(19) United States
(12) Patent Application Publication
(10) Pub. No.: US 2012/0086700 A1
(43) Pub. Date: Apr. 12, 2012

(54) Display Device And Method For Driving Same

(75) Inventor: Takaji Numao, Osaka-shi (JP)

(73) Assignee: SHARP KABUSHIKI KAISHA, Osaka-shi, Osaka (JP)

(21) Appl. No.: 13/376,244

(22) PCT Filed: Mar. 1, 2010
(86) PCT No.: PCT/JP2010/053257

§ 371 Date: Dec. 5, 2011

(30) Foreign Application Priority Data
Jun. 29, 2009 (JP) 2009-153199

(51) Int. Cl. G09G 3/36; G06F 3/038

(52) U.S. Cl. 345/212; 345/87

(57) ABSTRACT

There is provided a display device in which even if the amplitude of the voltage of a source wiring line is relatively small, the amplitudes of the voltages of subpixels can be increased and the voltage difference between the subpixels can be furthermore increased. In at least one example embodiment, voltages of equal magnitudes are provided to pixel electrodes in a first subpixel portion and a second subpixel portion from a source wiring line. Thereafter, by changing an applied voltage to an auxiliary capacitance wiring line, voltages of different magnitudes are provided to the pixel electrodes in the first subpixel portion and the second subpixel portion. By this, a voltage difference is generated between the pixel electrode in the first subpixel portion and the pixel electrode in the second subpixel portion.

### TECHNICAL FIELD

The present invention relates to a display device and more particularly to an active matrix-type liquid crystal display device using thin film transistors.

### BACKGROUND ART

In recent years, an increase in the size and achievement of high definition of liquid crystal display devices have been promoted. In addition, in liquid crystal televisions, an increase in the rate of drive frequency which is called “double speed (120 Hz)”, “quad-speed (240 Hz)”, etc., has also been promoted. As a result, there has been a noticeable increase in the amount of power required to drive the panel of a liquid crystal display device. The causes of the increase in the amount of power include that: the source wiring line capacitance and gate wiring line capacitance in the liquid crystal panel increase as an increase in size is promoted; the number of wiring lines in the liquid crystal panel increases as achievement of high definition is promoted; the number of times the wiring lines of the liquid crystal panel are charged and discharged increases as an increase in rate (an increase in frequency) is promoted; and so forth.

In addition, in recent years, there has also been a noticeable increase in the amount of heat generated in a source driver LSI. The reason for this is because the amount of current flowing through the source wiring lines has increased over conventional cases due to the increase in source wiring line capacitance and the increase in the number of times the source wiring lines are charged and discharged. When the on-resistance per output terminal of the source driver LSI is constant, if the amount of current passing through the output terminal increases, then the amount of heat generated also increases. If the temperature of the source driver LSI exceeds an acceptable range of temperatures as a result of the increase in the amount of heat generated, then the source driver LSI may cause abnormal operation or become inoperable.

FIG. 18 is a diagram showing a configuration example of pixel circuits in a conventional liquid crystal panel. FIG. 19 is a signal waveform diagram of the liquid crystal panel.

Liquid crystal has the property of deteriorating with continuous application of a DC voltage. Hence, in a liquid crystal display device, an AC voltage is applied to liquid crystal so that the polarity of an applied voltage to the liquid crystal can change every predetermined period. In addition, a large liquid crystal panel generally adopts dot-reversal driving (a driving scheme in which while the polarity of an applied voltage to the liquid crystal is reversed every adjacent pixels in vertical and horizontal directions, the polarity is also reversed every frame). Therefore, as shown in FIG. 19 (see reference characters S1 to S3), the polarity of a voltage supplied to a source wiring line Sj (j=1, 2, 3, . . . ) is reversed every line (every horizontal scanning period). Since the source wiring line is charged and discharged a number of times corresponding to the number of times the voltage is changed (the polarity of the voltage is reversed), the larger the liquid crystal panel, the larger the amount of heat generated in the source driver LSI.

In view of this, as a technique for suppressing heat generation in the source driver LSI, there is proposed a technique for reducing the amplitude of a voltage for when a source wiring line is charged and discharged. This will be described with reference to FIGS. 20A to 20C. FIGS. 20A to 20C are diagrams for describing the operation of a pixel in a liquid crystal display device disclosed in Japanese Patent Application Laid-Open No. 2002-202762. The liquid crystal display device adopts a driving scheme called CC driving (Capacitance Coupled Driving) using capacitance coupling. As shown in FIG. 20A, first, a TFT 116 is placed in an on state, whereby a voltage Vp with a relatively small amplitude is provided to a pixel electrode 118 from a source wiring line 114. Next, as shown in FIG. 20B, the TFT 116 is placed in an off state, and then the voltage of an auxiliary capacitance wiring line 113 is changed by Vq. By this, a voltage provided to an auxiliary capacitance Cstg changes, and charge accumulated in the auxiliary capacitance Cstg is released as shown in FIG. 20C, and thus the voltage of the pixel electrode 118 changes. Specifically, when the capacitance value of an auxiliary capacitance 119 connected to the pixel electrode 118 is Cstg and the capacitance value of a liquid crystal 105 is Clc, the voltage Vr of the pixel electrode 118 is represented by the following equation (1):

Vr=Vp+Vq·(Cstg/(Cstg+Clc)) (1).

By the above equation (1), it is grasped that the applied voltage to the pixel electrode 118 is larger by Vq·(Cstg/(Cstg+Clc)) than the applied voltage Vp to the source wiring line 114. In the above-described manner, the applied voltage to the source wiring line can be made smaller than the voltage to be applied to the pixel electrode. Namely, even if the amplitude of the applied voltage to the source wiring line is small, the amplitude of the voltage applied to the pixel electrode is increased based on the change in the voltage of the auxiliary capacitance wiring line. By this, the amplitude of a voltage to be provided to the source wiring line can be reduced, which consequently suppresses heat generation in the source driver LSI.

Note that in a display device adopting CC driving and dot-reversal driving, auxiliary capacitances are arranged in a staggered manner with reference to an auxiliary capacitance wiring line. FIG. 21 (FIG. 2 of Japanese Patent Application Laid-Open No. 2008-145993) is a diagram showing the configuration of pixel circuits in a liquid crystal display device adopting CC driving and dot-reversal driving. In FIG. 21, when taking a look at an auxiliary capacitance wiring line 20, auxiliary capacitances 24A are provided in a staggered manner.

Meanwhile, in recent years, in order to expand the viewing angle of a liquid crystal panel, pixel circuits which is configured such that one pixel Pij (i=1, 2, 3, . . . and j=1, 2, 3, . . . ) is divided into two subpixels Pija and Pijb as shown in FIG. 18 are adopted in many cases. In particular, liquid crystal televisions to be viewed by many people often adopt pixel circuits of the configuration shown in FIG. 18. In such a configuration, there is a need to generate a voltage difference between the pixel electrodes in the two subpixels Pija and Pijb. However, in a configuration in which both of the subpixels Pija and Pijb are connected to a single gate wiring line Gi (i=1, 2, 3, . . . ), even if voltages are provided to the pixel electrodes in the two subpixels Pija and Pijb from a single source wiring line Sj, a voltage difference cannot be generated between the pixel electrodes in the two subpixels Pija and Pijb, based on the voltages provided to the pixel electrodes from the source wiring line Sj.

In view of this, Japanese Patent Application Laid-Open No. 2005-189804 proposes a driving scheme called MPD driving (Multi Pixel Driving). In a display device adopting MPD driving, as shown in FIG. 18, auxiliary capacitances Cija and Cijb included in respective subpixels are connected to different auxiliary capacitance wiring lines Ci and Ci+1. Then, when voltages are provided to the pixel electrodes in the respective subpixels from a source wiring line Sj, voltages of different magnitudes are provided to the auxiliary capacitance wiring line Ci and the auxiliary capacitance wiring line Ci+1 (see FIG. 22). Since the applied voltages to the two auxiliary capacitance wiring lines Ci and Ci+1 change in the manner shown in FIG. 22, for effective voltages throughout one frame period, the applied voltage to the auxiliary capacitance wiring line Ci and the applied voltage to the auxiliary capacitance wiring line Ci+1 are equal. Hence, a difference occurs in the magnitude of an effective voltage applied to a pixel electrode (liquid crystal) between subpixels, based on the voltage difference between the auxiliary capacitance wiring lines Ci and Ci+1 which is generated when voltages are provided to the pixel electrodes in the respective subpixels from the source wiring line Sj. Note that in the following the difference between the voltage of a pixel electrode in one subpixel and the voltage of a pixel electrode in the other subpixel is simply called a “voltage difference between subpixels”.

Japanese Patent Application Laid-Open No. 2006-139288 proposes another configuration example for generating a voltage difference between subpixels. According to the configuration example, as shown in FIG. 23, an auxiliary capacitance Csta is provided in one subpixel PXa and the auxiliary capacitance Csta is connected to an auxiliary capacitance wiring line SL. In addition, a coupling capacitance Ccp is provided between two subpixels PXa and PXb. According to such a configuration, the timing at which a thin film transistor Qa connected to a gate wiring line GLa is placed in an on state can be made different from the timing at which a thin film transistor Qb connected to a gate wiring line GLb is placed in an on state. Hence, by making the magnitude of an applied voltage to a source wiring line DL for when the thin film transistor Qa is in an on state different from the magnitude of an applied voltage to the source wiring line DL for when the thin film transistor Qb is in an on state, a voltage difference can be generated between the subpixels. In addition, when voltages of the same waveform are applied to the two gate wiring lines GLa and GLb, too, comparing between the subpixel PXa and the subpixel PXb, the subpixel PXa receives a greater influence exerted by a change in the voltage of the auxiliary capacitance wiring line SL. This is because the subpixel PXb receives the influence of a change in the voltage of the subpixel PXa through the coupling capacitance Ccp. In the above-described manner, a voltage difference can be generated between the subpixels by the configuration shown in FIG. 23.

### PRIOR ART DOCUMENTS

### Patent Documents

[Patent Document 1] Japanese Patent Application Laid-Open No. 2002-202762
[Patent Document 2] Japanese Patent Application Laid-Open No. 2008-145993
[Patent Document 3] Japanese Patent Application Laid-Open No. 2005-189804
[Patent Document 4] Japanese Patent Application Laid-Open No. 2006-139288

### SUMMARY OF THE INVENTION

### Problems to be Solved by the Invention

Meanwhile, when the configuration is such that voltages of the same waveform are provided to two gate wiring lines GLa and GLb using the pixel circuit shown in FIG. 23, as with the liquid crystal display device disclosed in Japanese Patent Application Laid-Open No. 2002-202762, the amplitude of a voltage to be applied to a source wiring line can be reduced. In addition, as with the liquid crystal display device disclosed in Japanese Patent Application Laid-Open No. 2005-189804, a voltage difference can be generated between subpixels. However, in that configuration, the voltage difference between subpixels cannot be increased significantly. This will be described below.

In the configuration shown in FIG. 23, it is assumed that the thin film transistors Qa and Qb are simultaneously placed in an on state, a voltage Vda is provided to pixel electrodes Xa and Xb in the subpixels PXa and PXb from the source wiring

$$\begin{matrix} Clcb + Ccp ) Δ Vsl + Ccp \cdot ( Clcb \cdot Vda + Ccp \cdot Vxa ) . & ( 7 ) \\ ∴ ( ( Clca + Ccp + Csta ) ( Clcb + Ccp ) - Ccp \cdot Ccp ) Vxa = ( ( Clca + Csta ) ( Clcb + Ccp ) + Ccp \cdot Clcb ) Vda + Csta ( Clcb + Ccp ) Δ Vsl & ( 8 ) \\ ∴ ( ( Clca + Csta ) ( Clcb + Ccp ) + Ccp \cdot Clcb ) Vxa = ( ( Clca + Csta ) ( Clcb + Ccp ) + Ccp \cdot Clcb ) Vda + Csta ( Clcb + Ccp ) Δ Vsl & ( 9 ) \\ ∴ Vxa = Vda + Δ Vsl \cdot Csta ( Clcb + Ccp ) / ( ( Clca + Csta ) ( Clcb + Ccp ) + Ccp \cdot Clcb ) . & ( 10 )\end{matrix}$$

In the above equation (10), when Clca=Clcb=Ccp=Csta, the following equation (11) is established:

Vxa=Vda+ΔVsl·2/5 (11).

The above equation (3) can be transformed into the following equation (12):

$$\begin{matrix}Vxb = ( Clcb \cdot Vda + Ccp \cdot Vxa ) / ( Clcb + Ccp ) \\ = ( Clcb \cdot Vda + Ccp ( Vda + Δ Vsl \cdot 2 / 5 ) ) / ( Clcb + Ccp ) \\ = Vda + Ccp ( Δ Vsl \cdot 2 / 5 ) / ( Clca + Ccp ) \\ = Vda + Δ Vsl \cdot ( 1 / 5 ) .\end{matrix} \qquad ( 12 )$$

As is grasped from the above equation (11), the change in the voltage of the subpixel PXa is on the order of two-fifths of the change ΔVsl in the voltage of the auxiliary capacitance wiring line SL. In addition, as is grasped from the above equation (12), the change in the voltage of the subpixel PXb is on the order of one-fifths of the change ΔVsl in the voltage of the auxiliary capacitance wiring line SL. As such, in the configuration shown in FIG. 23, the influence exerted by the change in the voltage of the auxiliary capacitance wiring line SL on the voltages of the pixel electrodes in the subpixels is relatively small. Hence, the voltage difference between the subpixels cannot be increased significantly.

An object of the present invention is therefore to provide a display device in which even if the amplitude of the voltage of a source wiring line is relatively small, the amplitudes of the voltages of subpixels can be increased and the voltage difference between the subpixels can be furthermore increased.

### Means for Solving the Problems

A first aspect of the present invention is directed to a display device comprising:

a pixel formation portion composed of a first subpixel portion including a first active element, a first capacitance element, and a first pixel electrode; and a second subpixel portion including a second active element, a second capacitance element, and a second pixel electrode;

a video signal line electrically connected to the first pixel electrode through the first active element, and electrically connected to the second pixel electrode through the second active element;

a scanning signal line provided to intersect the video signal line, and transmitting a scanning signal for controlling conducting/non-conducting states of the first active element and/or the second active element;

an auxiliary capacitance wiring line electrically connected to the first pixel electrode through the first capacitance element, and electrically connected to the second pixel electrode through the second capacitance element; and

a pixel electrode voltage shift portion that changes applied voltages to the first pixel electrode and the second pixel electrode by changing an applied voltage to the auxiliary capacitance wiring line, wherein

the pixel electrode voltage shift portion changes the applied voltages to the first pixel electrode and the second pixel electrode, whereby an effective voltage of the first pixel electrode is made different in magnitude from an effective voltage of the second pixel electrode.

According to a second aspect of the present invention, in the first aspect of the present invention,

during each frame period,
during a first period, voltages which are determined according to an image to be displayed are provided to the first pixel electrode and the second pixel electrode from the video signal line, the first period being a period during which the first active element and/or the second active element are(is) placed in a conducting state based on the scanning signal, and
during a second period, the pixel electrode voltage shift portion changes the applied voltage to the auxiliary capacitance wiring line, whereby different voltages are provided to the first pixel electrode and the second pixel electrode, the second period being a period subsequent to the first period.

According to a third aspect of the present invention, in the first aspect of the present invention,

a capacitance value of the first capacitance element and a capacitance value of the second capacitance element differ from each other.

According to a fourth aspect of the present invention, in the first aspect of the present invention,

when taking a look at one video signal line, a plurality of pixel formation portions including a first and a second active element are arranged in a staggered manner on both sides of the video signal line, the first and second active elements being electrically connected to the video signal line.

According to a fifth aspect of the present invention, in the third aspect of the present invention,

a first scanning signal line and a second scanning signal line are provided as the scanning signal line, the first scanning signal line transmitting a scanning signal for controlling the conducting/non-conducting states of the first active element, and the second scanning signal line transmitting a scanning signal for controlling the conducting/non-conducting states of the second active element,

the pixel formation portion includes a third active element connected at its control terminal to the first scanning signal line, connected at its one conduction terminal to the second pixel electrode, and connected at its other conduction terminal to the auxiliary capacitance wiring line,

the first capacitance element is connected at its one end to the first pixel electrode and connected at its other end to the second pixel electrode,

the second capacitance element is connected at its one end to the second pixel electrode and connected at its other end to the auxiliary capacitance wiring line,

the first active element is connected at its control terminal to the first scanning signal line, connected at its one conduction terminal to the video signal line, and connected at its other conduction terminal to the first pixel electrode, and

the second active element is connected at its control terminal to the second scanning signal line, connected at its one conduction terminal to the video signal line, and connected at its other conduction terminal to the second pixel electrode.

According to a sixth aspect of the present invention, in the fifth aspect of the present invention,

during a first half period of the first period, the first active element and the third active element are placed in a conducting state and the second active element is placed in a non-conducting state, and

during a second half period of the first period, the first active element and the third active element are placed in a non-conducting state and the second active element is placed in a conducting state.

According to a seventh aspect of the present invention, in the first aspect of the present invention,

the display device further comprises a first and a second correction wiring line intersecting the auxiliary capacitance wiring line;

a third capacitance element connected at its one end to the first pixel electrode and connected at its other end to the first correction wiring line; and

a fourth capacitance element connected at its one end to the second pixel electrode and connected at its other end to the second correction wiring line, wherein

the first capacitance element is connected at its one end to the first pixel electrode and connected at its other end to the auxiliary capacitance wiring line, and

the second capacitance element is connected at its one end to the second pixel electrode and connected at its other end to the auxiliary capacitance wiring line.

According to an eighth aspect of the present invention, in the first aspect of the present invention,

an electrode pattern of the first pixel electrode and an electrode pattern of the second pixel electrode differ from each other.

A ninth aspect of the present invention is directed to a drive method for a display device including a pixel formation portion composed of a first subpixel portion including a first active element, a first capacitance element, and a first pixel electrode; and a second subpixel portion including a second active element, a second capacitance element, and a second pixel electrode; a video signal line electrically connected to the first pixel electrode through the first active element, and electrically connected to the second pixel electrode through the second active element; a scanning signal line provided to intersect the video signal line, and transmitting a scanning signal for controlling conducting/non-conducting states of the first active element and/or the second active element; and an auxiliary capacitance wiring line electrically connected to the first pixel electrode through the first capacitance element, and electrically connected to the second pixel electrode through the second capacitance element, the drive method comprising:

a first driving step of providing voltages which are determined according to an image to be displayed to the first pixel electrode and the second pixel electrode from the video signal line; and

a second driving step of changing the applied voltages to the first pixel electrode and the second pixel electrode by changing an applied voltage to the auxiliary capacitance wiring line, wherein

by changing the applied voltages to the first pixel electrode and the second pixel electrode in the second driving step, an effective voltage of the first pixel electrode and an effective voltage of the second pixel electrode are set to different magnitudes.

### Effects of the Invention

According to the first aspect of the present invention, a pixel formation portion is composed of a first subpixel portion and a second subpixel portion. By a pixel electrode voltage shift portion changing an applied voltage to an auxiliary capacitance wiring line, the voltages of pixel electrodes in the two subpixel portions change. Hence, the amplitudes of the voltages of the pixel electrodes become greater than the amplitude of a voltage provided to a video signal line. By this, the amplitude of the applied voltage to the video signal line can be reduced over conventional cases. In addition, by changing the voltage of the pixel electrode in each subpixel portion by the pixel electrode voltage shift portion, an effective voltage of a first pixel electrode (the pixel electrode in the first subpixel portion) is made different in magnitude from an effective voltage of a second pixel electrode (the pixel electrode in the second subpixel portion). From the above, a display device is implemented in which even if the amplitude of an applied voltage to a video signal line is relatively small, the amplitudes of the voltages of subpixels can be increased and the voltage difference between the subpixels can be furthermore increased.

According to the second aspect of the present invention, as with the first aspect of the present invention, a display device is implemented in which even if the amplitude of an applied voltage to a video signal line is relatively small, the amplitudes of the voltages of subpixels can be increased and the voltage difference between the subpixels can be furthermore increased.

According to the third aspect of the present invention, the level of the influence exerted by a change in the applied voltage to the auxiliary capacitance wiring line can be made different between the first pixel electrode and the second pixel electrode. By this, a voltage difference can be generated between subpixels, with a simple configuration.

According to the fourth aspect of the present invention, when dot-reversal driving is adopted, there is no need to reverse the polarity of an applied voltage to each video signal line every horizontal scanning period and thus the polarities of applied voltages to each video signal line are made to be the same throughout one frame period. Hence, since the number of times the video signal lines are charged and discharged is reduced, power consumption is reduced and an increase in the amount of heat generated in a video signal line driving LSI is suppressed.

According to the fifth aspect of the present invention, in a configuration in which active elements in two subpixel portions are controlled by scanning signals from different scanning signal lines, the level of the influence exerted by a change in the applied voltage to the auxiliary capacitance wiring line can be made different between the first pixel electrode and the second pixel electrode.

According to the sixth aspect of the present invention, as with the fifth aspect of the present invention, in a configuration in which active elements in two subpixel portions are controlled by scanning signals from different scanning signal lines, the level of the influence exerted by a change in the applied voltage to the auxiliary capacitance wiring line can be made different between the first pixel electrode and the second pixel electrode.

According to the seventh aspect of the present invention, by providing different voltages to a first correction wiring line and a second correction wiring line, a voltage difference can be generated between subpixels.

According to the eighth aspect of the present invention, since the magnitude of an electric field received by liquid crystal through the first pixel electrode differs from the magnitude of an electric field received by liquid crystal through the second pixel electrode, the difference in grayscale characteristics between subpixels becomes significant.

### BRIEF DESCRIPTION OF THE DRAWINGS

FIG. 1 is a circuit diagram showing the configuration of pixel circuits in a liquid crystal display device according to a first embodiment of the present invention.

FIG. 2 is a block diagram showing an overall configuration of the liquid crystal display device in the first embodiment.

FIG. 3 is a diagram for describing a pixel formation portion in the first embodiment.

FIG. 4 is a signal waveform diagram for describing a drive method in the first embodiment.

FIG. 5 is a diagram for describing effects in the first embodiment.

FIG. 6 is a block diagram showing an overall configuration of a liquid crystal display device according to a second embodiment of the present invention.

FIG. 7 is a circuit diagram showing the configuration of pixel circuits in the second embodiment.

FIG. 8 is a signal waveform diagram for describing a drive method in the second embodiment.

FIG. 9 is a diagram for describing the drive method in the second embodiment.

FIG. 10 is a diagram for describing the drive method in the second embodiment.

FIG. 11 is a diagram for describing effects in the second embodiment.

FIG. 12 is a block diagram showing an overall configuration of a liquid crystal display device according to a third embodiment of the present invention.

FIG. 13 is a circuit diagram showing the configuration of pixel circuits in the third embodiment.

FIG. 14 is a signal waveform diagram for describing a drive method in the third embodiment.

FIG. 15 is a diagram showing the electrode patterns of pixel electrodes in a variant of the first to third embodiments.

FIG. 16 is a cross-sectional view along line A-A of FIG. 15.

FIG. 17 is a cross-sectional view along line B-B of FIG. 15.

FIG. 18 is a diagram showing a configuration example of pixel circuits in a conventional liquid crystal panel.

FIG. 19 is a signal waveform diagram of the conventional liquid crystal panel.

FIGS. 20A to 20C are diagrams for describing the operation of a pixel in a liquid crystal display device disclosed in Japanese Patent Application Laid-Open No. 2002-202762.

FIG. 21 is a diagram showing the configuration of pixel circuits in a liquid crystal display device disclosed in Japanese Patent Application Laid-Open No. 2008-145993.

FIG. 22 is a signal waveform diagram of a display device adopting MPD driving in a conventional example.

FIG. 23 is a circuit diagram showing the configuration of pixel circuits in a display device disclosed in Japanese Patent Application Laid-Open No. 2006-139288.

### MODE FOR CARRYING OUT THE INVENTION

Embodiments of the present invention will be described below with reference to the accompanying drawings.

### 1. First Embodiment

<1.1 Overall Configuration>

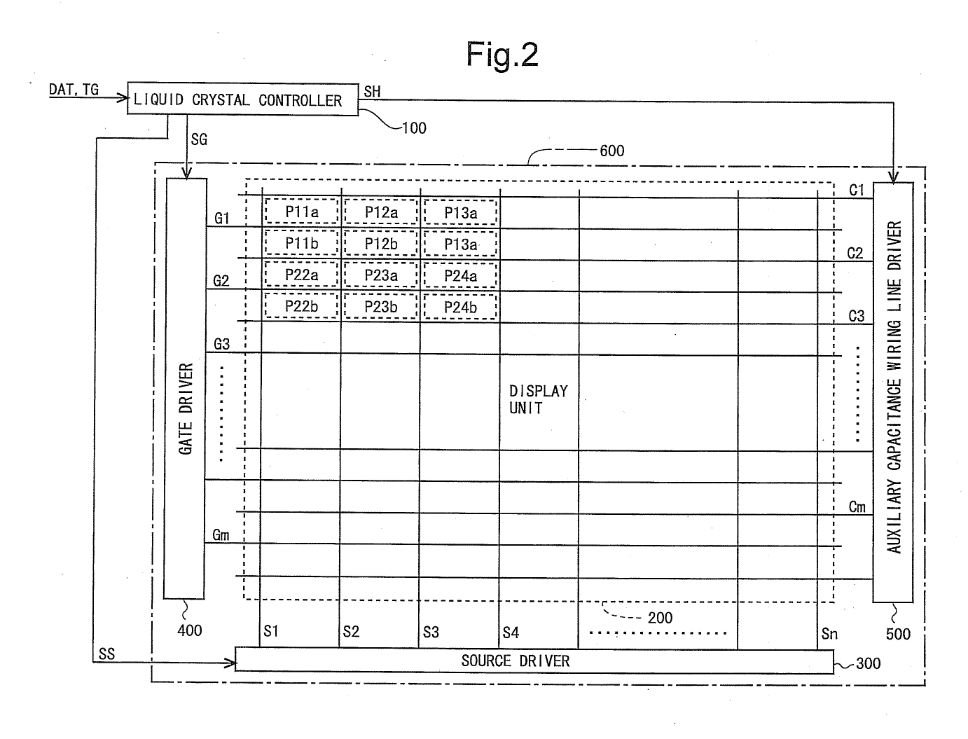

FIG. 2 is a block diagram showing an overall configuration of a liquid crystal display device according to a first embodiment of the present invention. The liquid crystal display device is composed of a liquid crystal panel 600 and a liquid crystal controller 100. The liquid crystal panel 600 includes a display unit 200, a source driver (video signal line drive circuit) 300, a gate driver (scanning signal line drive circuit) 400, and an auxiliary capacitance wiring line driver (auxiliary capacitance wiring line drive circuit) 500. Note that in FIG. 2 a polarizing plate and a backlight which are disposed on the front and back sides of the liquid crystal panel 600 are omitted. Also, it is assumed that the liquid crystal display device performs 256-level grayscale display.

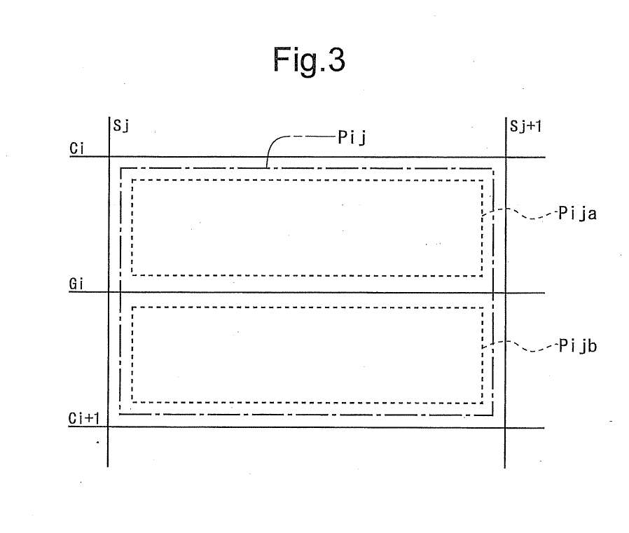

The display unit 200 includes n source wiring lines (video signal lines) S1 to Sn, m gate wiring lines (scanning signal lines) G1 to Gm, and a plurality of (n×m) pixel formation portions provided at the respective intersections of the n source wiring lines and the m gate wiring lines. In addition, in the display unit 200, m auxiliary capacitance wiring lines C1 to Cm are provided so as to have a one-to-one correspondence with the gate wiring lines G1 to Gm. Meanwhile, in the present embodiment, one pixel is divided into two subpixels in order to expand the viewing angle. Therefore, each of the plurality of pixel formation portions includes two subpixel formation portions which form subpixels. Note that in the following a pixel formation portion arranged in an i row and a j column is denoted by reference character Pij, one subpixel formation portion (hereinafter, also referred to as a “first subpixel portion”) included in the pixel formation portion Pij is denoted by reference character Pija, and the other subpixel formation portion (hereinafter, also referred to as a “second subpixel portion”) included in the pixel formation portion Pij is denoted by reference character Pijb (see FIG. 3).

The liquid crystal controller 100 receives a data signal DAT and a timing control signal group TG which are sent from an external source, and outputs a source control signal group SS for controlling the operation of the source driver 300, a gate control signal group SG for controlling the operation of the gate driver 400, and an auxiliary capacitance wiring line control signal group SH for controlling the operation of the auxiliary capacitance wiring line driver 500. The source driver 300 receives the source control signal group SS and applies driving video signals to the source wiring lines S1 to Sn to charge pixel capacitances in the respective subpixel formation portions in the display unit 200. The gate driver 400 receives the gate control signal group SG and sequentially applies selection signals (scanning signals) to the gate wiring lines G1 to Gm. The auxiliary capacitance wiring line driver 500 receives the auxiliary capacitance wiring line control signal group SH and applies auxiliary capacitance wiring line drive signals to the auxiliary capacitance wiring lines Cl to Cm.

By thus applying the driving video signals to the respective source wiring lines S1 to Sn, applying the selection signals to the respective gate wiring lines G1 to Gm, and applying the auxiliary capacitance wiring line drive signals to the respective auxiliary capacitance wiring lines C1 to Cm, an image is displayed on the display unit 200.

<1.2 Configuration of Pixel Circuits>

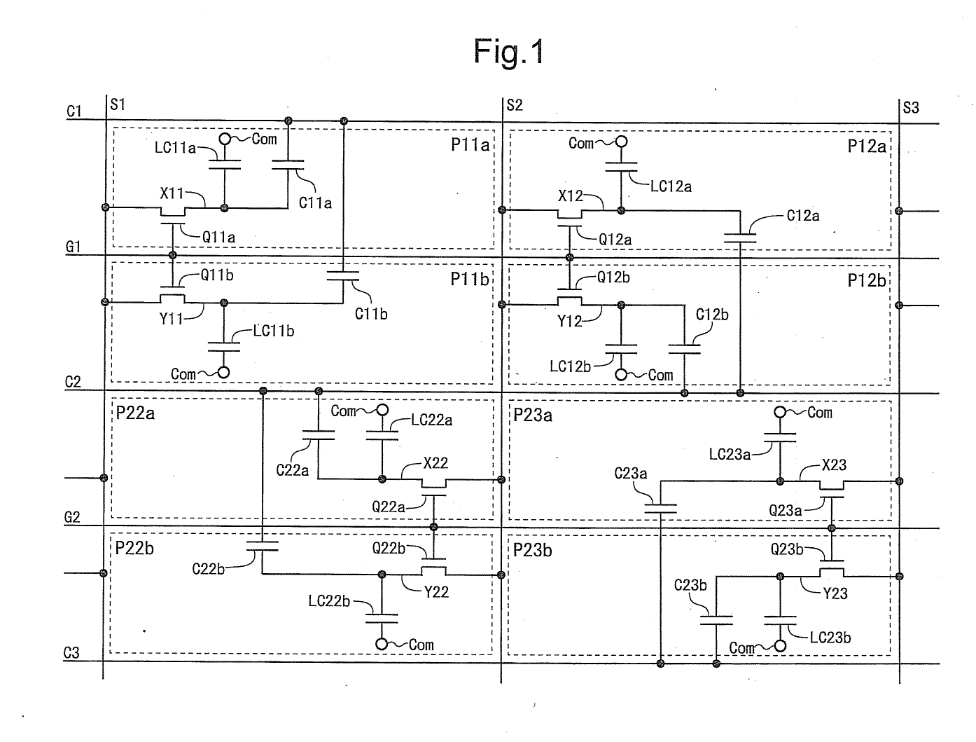

FIG. 1 is a circuit diagram showing the configuration of pixel circuits in the present embodiment. As shown in FIG. 1, two subpixel formation portions Pija and Pijb are arranged at an intersection of a source wiring line Sj and a gate wiring line G1. The first subpixel portion Pija is composed of a thin film transistor Qija which is an active element, a pixel electrode Xij, and an auxiliary capacitance Cija which is a capacitor. Likewise, the second subpixel portion Pijb is composed of a thin film transistor Qijb which is an active element, a pixel electrode Yij, and an auxiliary capacitance Cijb which is a capacitor. The thin film transistor Qija is connected at its gate terminal to the gate wiring line Gi, connected at its source terminal to the source wiring line Sj, and connected at its drain terminal to the pixel electrode Xij. The auxiliary capacitance Cija is arranged between the pixel electrode Xij and an auxiliary capacitance wiring line Ci (or an auxiliary capacitance wiring line Ci+1). The thin film transistor Qijb is connected at its gate terminal to the gate wiring line G1, connected at its source terminal to the source wiring line Sj, and connected at its drain terminal to the pixel electrode Yij. The auxiliary capacitance Cijb is arranged between the pixel electrode Yij and the auxiliary capacitance wiring line Ci (or the auxiliary capacitance wiring line Ci+1).

Note that in the present embodiment a first active element is implemented by the thin film transistor Qija, a first capacitance element is implemented by the auxiliary capacitance Cija, and a first pixel electrode is implemented by the pixel electrode Xij. In addition, a second active element is implemented by the thin film transistor Qijb, a second capacitance element is implemented by the auxiliary capacitance Cijb, and a second pixel electrode is implemented by the pixel electrode Yij. Furthermore, a pixel electrode voltage shift portion is implemented by a connection relationship among the pixel electrode Xij, the auxiliary capacitance Cija, and the auxiliary capacitance wiring line Ci, a connection relationship among the pixel electrode Yij, the auxiliary capacitance Cijb, and the auxiliary capacitance wiring line Ci, and the auxiliary capacitance wiring line driver 500.

In the configuration shown in FIG. 1, in the present embodiment, it is designed such that the capacitance value Ca of the auxiliary capacitance Cija and the capacitance value Cb of the auxiliary capacitance Cijb differ from each other. In addition, liquid crystal is present between the pixel electrodes Xij and Yij and a counter electrode Com. In terms of equivalence, a liquid crystal capacitance LCija is arranged between the pixel electrode Xij and the counter electrode Com, and a liquid crystal capacitance LCijb is arranged between the pixel electrode Yij and the counter electrode Corn. Then, light entering the liquid crystal (layer) from the backlight through the polarizing plate is polarized according to the magnitude of a voltage applied to the liquid crystal, whereby the display states of subpixels are controlled.

Taking a look at pixel formation portions provided for a source wiring line S2 in FIG. 1, a pixel formation portion P12 (subpixels P12a and P12b) provided for a gate wiring line G1 is arranged on the right side of the source wiring line S2 in FIG. 1, and a pixel formation portion P22 (subpixels P22a and P22b) provided for a gate wiring line G2 is arranged on the left side of the source wiring line S2 in FIG. 1. As such, a pixel formation portion Pij and a pixel formation portion P(i+1)j which are provided for a source wiring line Sj are arranged on different sides (i.e., in a staggered manner) with reference to the source wiring line Sj. Hence, for example, by setting the polarity of an applied voltage to a source wiring line Sj to a positive polarity throughout a first frame period and to a negative polarity throughout a second frame period, and setting the polarity of an applied voltage to a source wiring line Sj+1 to a negative polarity throughout the first frame period and to a positive polarity throughout the second frame period, dot-reversal driving is performed. Namely, dot-reversal driving is performed without reversing the polarity of an applied voltage to a source wiring line every horizontal scanning period.

<1.3 Drive Method>

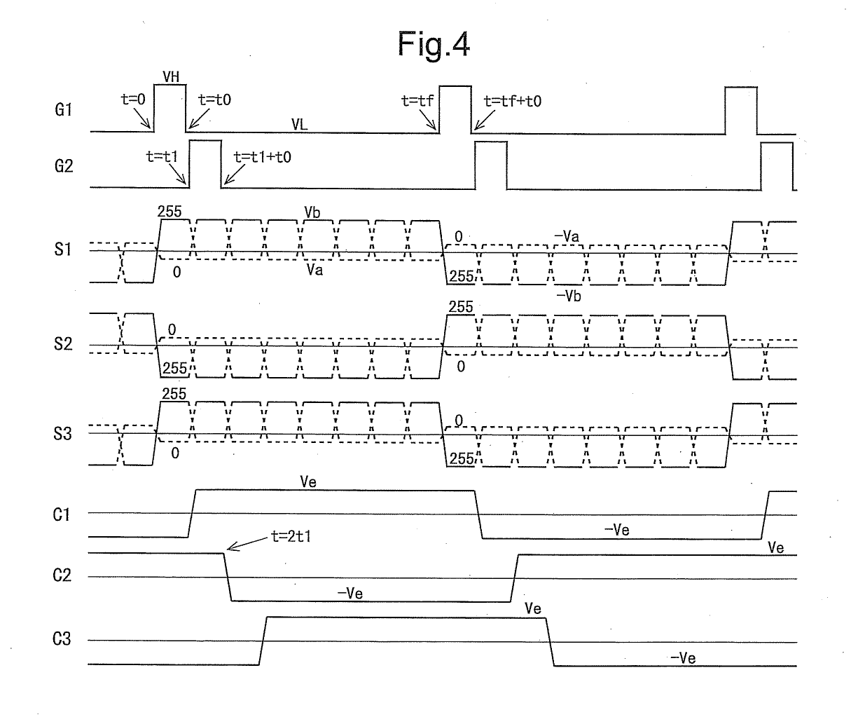

FIG. 4 is a signal waveform diagram for describing a drive method in the present embodiment. FIG. 4 shows the waveforms of a voltage applied to the gate wiring line G1, a voltage applied to the gate wiring line G2, a voltage applied to the source wiring line S1, a voltage applied to the source wiring line S2, a voltage applied to the source wiring line S3, a voltage applied to the auxiliary capacitance wiring line C1, a voltage applied to the auxiliary capacitance wiring line C2, and a voltage applied to the auxiliary capacitance wiring line C3.

A drive method in the present embodiment will be described below with reference to FIGS. 1 and 4. First, at time point t=0, the gate driver 400 sets the voltage of the gate wiring line G1 to VH. By this, thin film transistors Q1ja and Q1jb provided for the gate wiring line G1 are placed in an on state. Then, a positive polarity voltage is provided to pixel electrodes X11 and Y11 from the source wiring line S1 by the source driver 300. In addition, a negative polarity voltage is provided to pixel electrodes X12 and Y12 from the source wiring line S2 by the source driver 300.

Then, at time point t=t0, the gate driver 400 sets the voltage of the gate wiring line G1 to VL. By this, the thin film transistors Q1ja and Q1jb provided for the gate wiring line G1 are placed in an off state. Thereafter, at time point t=t1, the auxiliary capacitance wiring line driver 500 changes the voltage of the auxiliary capacitance wiring line C1 from −Ve to Ve. In addition, at time point t=t1, the gate driver 400 sets the voltage of the gate wiring line G2 to VH. By this, thin film transistors Q2ja and Q2jb provided for the gate wiring line G2 are placed in an on state. Then, a negative polarity voltage is provided to pixel electrodes X22 and Y22 from the source wiring line S2 by the source driver 300. In addition, a positive polarity voltage is provided to pixel electrodes X23 and Y23 from the source wiring line S3 by the source driver 300.

Then, at time point t=t1+t0, the gate driver 400 sets the voltage of the gate wiring line G2 to VL. By this, the thin film transistors Q2ja and Q2jb provided for the gate wiring line G2 are placed in an off state. Thereafter, at time point t=2t1 (timing at which the voltage of the gate wiring line G3 is set to VH), the auxiliary capacitance wiring line driver 500 changes the voltage of the auxiliary capacitance wiring line C2 from Ve to −Ve.

Meanwhile, the other ends of auxiliary capacitances C11a and C11b which are connected at their one ends to the pixel electrodes X11 and Y11 to which a positive polarity voltage is provided, are connected to the auxiliary capacitance wiring line C1. On the other hand, the other ends of auxiliary capacitances C12a and C12b which are connected at their one ends to the pixel electrodes X12 and Y12 to which a negative polarity voltage is provided, are connected to the auxiliary capacitance wiring line C2. The voltages applied to the source wiring line S1 during the above-described period (time point t=0 to 2t1) are, as shown in FIG. 4, Va (a voltage corresponding to grayscale value 0) to Vb (a voltage corresponding to grayscale value 255). Here, it is assumed that at time point t=t0 a voltage Vda is provided to the pixel electrode X11 and the pixel electrode Y11. At this time, when the voltage of the pixel electrode X11 at time point t=2t1 is Vx and the voltage of the pixel electrode Y11 is Vy, the voltage Vx is obtained as shown in the following equations (13) to (15):

Clca(Vda−Vc)+Ca(Vda−(−Ve))=Clca(Vx−Vc)+Ca(Vx−Ve) (13)

∴(Clca+Ca)Vx=(Clca+Ca)Vda+2CaVe (14)

∴Vx=Vda+(2Ca/(Clca+Ca))Ve (15)

where Clca is the capacitance value of a liquid crystal capacitance LC11a and Ca is the capacitance value of the auxiliary capacitance C11a. Vc is the voltage value of a counter electrode Com.

In a likewise manner, the voltage Vy is obtained as shown in the following equations (16) to (18):

Clcb(Vda−Vc)+Cb(Vda−(−Ve))=Clcb(Vy−Vc)+Cb(Vy−Ve) (16)

∴(Clcb+Cb)Vy=(Clcb+Cb)Vda+2CbVe (17)

∴Vy=Vda+(2Cb/(Clcb+Cb))Ve (18)

where Clcb is the capacitance value of a liquid crystal capacitance LC11b and Cb is the capacitance value of the auxiliary capacitance C11b.

By the above equation (15) and the above equation (18), the voltage difference between the pixel electrode X11 and the pixel electrode Y11 is represented by the following equation (19):

Vx−Vy=((2Ca/(Clca+Ca))−(2Cb/(Clcb+Cb)))Ve (19).

<1.4 Effects>

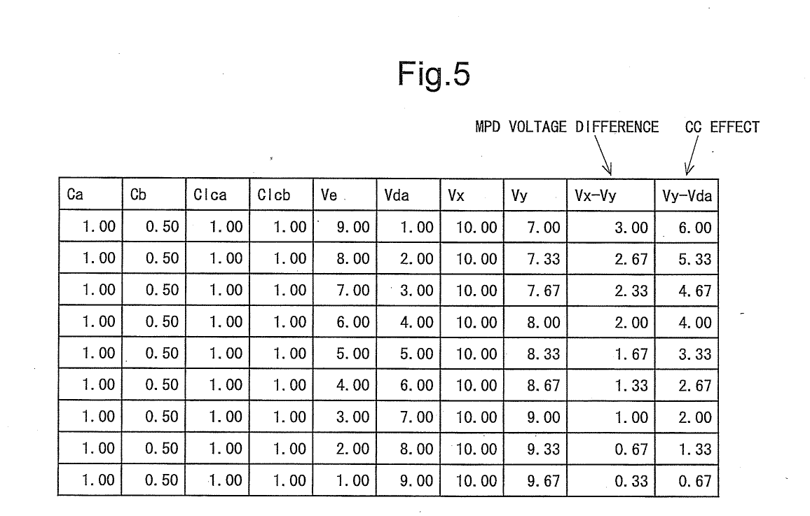

Effects in the present embodiment will be described. FIG. 5 shows the “relationship between the voltage Ve and the voltage Vda” to set the above-described Vx to 10 V when Ca=Clca=Clcb and Ca=2Cb. As is grasped from FIG. 5, by adjusting the magnitude of the voltage Ve and the magnitude of the voltage Vda, the voltage difference Vx−Vy between subpixels can be changed. This fact indicates that even if there are variations in the capacitance values Ca and Cb of auxiliary capacitances C11a and C11b between panels, by adjusting the magnitude of the voltage Ve and the magnitude of the voltage Vda to appropriate magnitudes, desired voltages are provided to a pixel electrode X11 and a pixel electrode Y11.

Note that as is grasped from FIG. 5, by adjusting a voltage between subpixels, the CC driving effect also changes. Hence, even if a panel is designed such that a voltage Vd255 (of the source wiring line) associated with positive polarity gray level 255 is equal to a voltage −Vd0 (of the source wiring line) associated with negative polarity gray level 0, the following problem arises. Specifically, taking into account variations in capacitance values Ca and Cb, an adjustment to the above-described voltages Ve and Vda is required according to panel and thus there may be a case in which Vd255 and −Vd0 have extremely different values. Considering this fact, even if CC driving is not used, it is preferred to design such that applied voltages to pixel electrodes in pixel formation portions Pij provided for a single source wiring line Sj have the same polarity throughout one frame period. In this regard, according to the present embodiment, as shown in FIG. 1, when taking a look at an arbitrary source wiring line Sj, pixel formation portions Pij and P(i+1)j are alternately arranged on the left and right sides of the source wiring line Sj (arranged in a staggered manner). By such an arrangement, the polarities of applied voltages to the source wiring line Sj are made to be the same throughout one frame period, and thus, an increase in the amount of the charge and discharge currents of the source wiring line Sj is suppressed. By this, power consumption is reduced and an increase in the amount of heat generated in the source driver 300 is suppressed.

In addition, if the condition “Ve>0” is satisfied even after an adjustment to the voltages Ve and Vda is made, then the voltages Vx and Vy of pixel electrodes in two subpixel formation portions become larger than the voltage Vda provided from the source wiring line Sj (to the pixel electrodes). Namely, even if the amplitude of an applied voltage to the source wiring line Sj is relatively small, a relatively large voltage can be applied to a pixel electrode in each subpixel formation portion. Therefore, an increase in the amplitude of an applied voltage to the source wiring line Sj is suppressed and thus heat generation in the source driver LSI is suppressed.

As described above, according to the present embodiment, a display device is implemented in which even if the amplitude of the voltage of a source wiring line is relatively small, the amplitudes of the voltages of subpixels can be increased and the voltage difference between the subpixels can be furthermore increased.

### 2. Second Embodiment

<2.1 Overall Configuration>

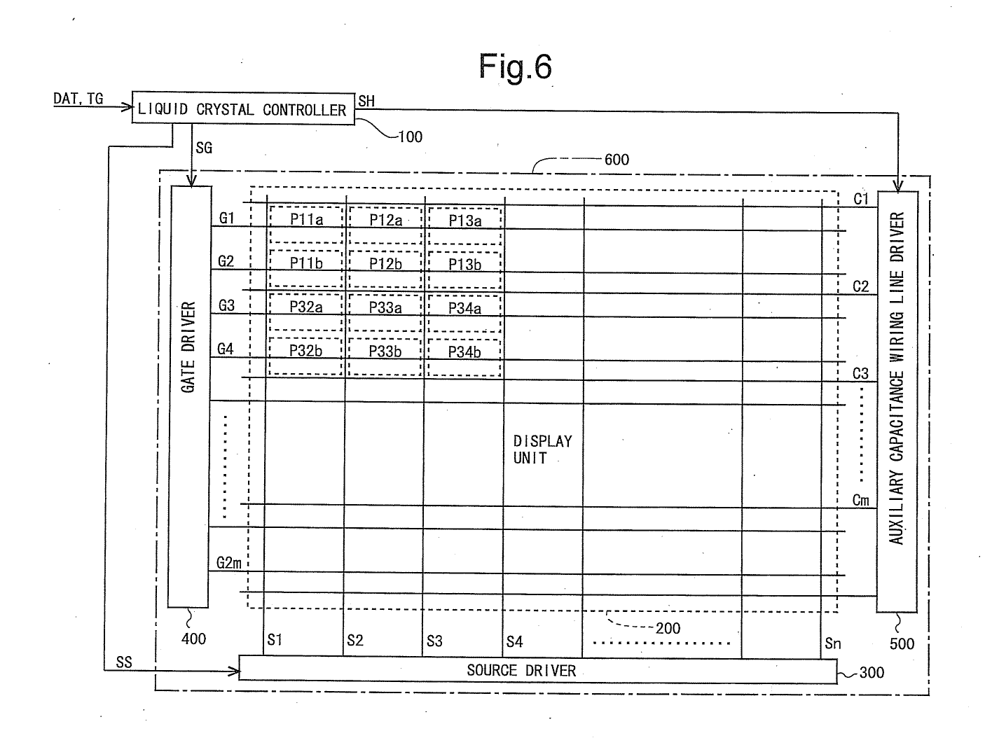

FIG. 6 is a block diagram showing an overall configuration of a liquid crystal display device according to a second embodiment of the present invention. The liquid crystal display device is composed of a liquid crystal panel 600 and a liquid crystal controller 100. The liquid crystal panel 600 includes a display unit 200, a source driver (video signal line drive, circuit) 300, a gate driver (scanning signal line drive circuit) 400, and an auxiliary capacitance wiring line driver (auxiliary capacitance wiring line drive circuit) 500. Note that in FIG. 6 a polarizing plate and a backlight which are disposed on the front and back sides of the liquid crystal panel 600 are omitted. Also, it is assumed that the liquid crystal display device performs 256-level grayscale display. The operation of each component is the same as that in the above-described first embodiment and thus description thereof is omitted.

<2.2 Configuration of Pixel Circuits>

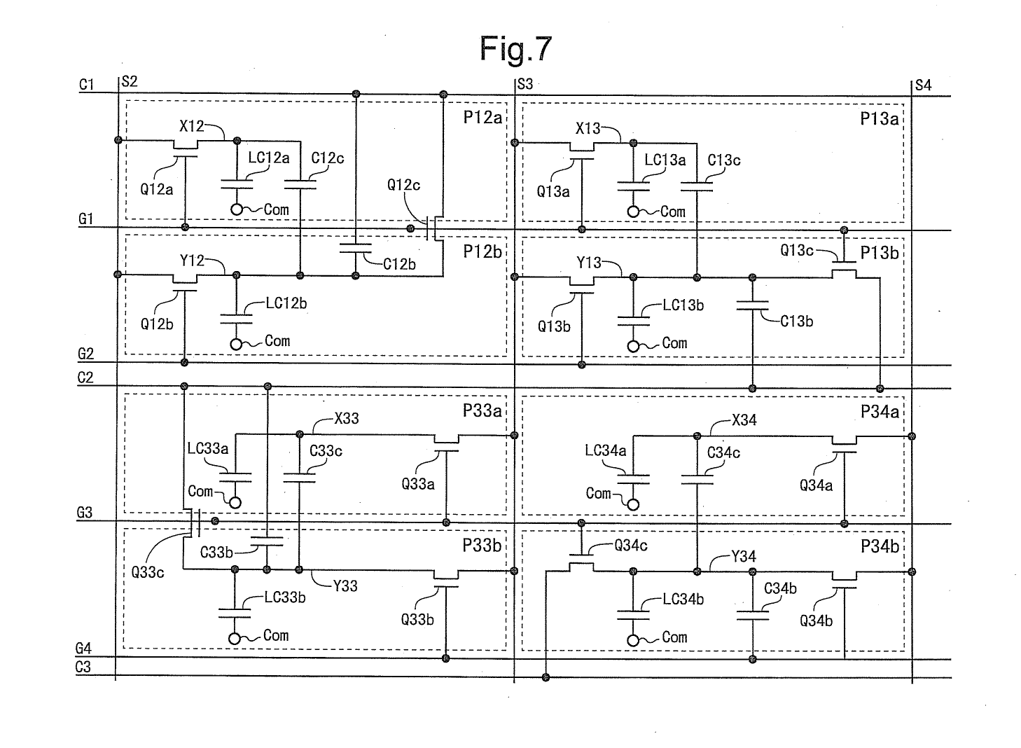

FIG. 7 is a circuit diagram showing the configuration of pixel circuits in the present embodiment. As shown in FIG. 7, two subpixel formation portions P(2i−1)ja and P(2i−1)jb are arranged at an intersection of a source wiring line Sj and a gate wiring line G2i−1. An auxiliary capacitance C(2i−1)jc which is a capacitor is arranged between a pixel electrode X(2i−1)j in the first subpixel portion P(2i−1)ja and a pixel electrode Y(2i−1)j in the second subpixel portion P(2i−1)jb. A thin film transistor Q(2i−1)ja which is an active element is arranged between the pixel electrode X(2i−1)j and the source wiring line Sj. An auxiliary capacitance C(2i−1)jb which is a capacitor and a thin film transistor Q(2i−1)jc which is an active element are arranged in parallel between the pixel electrode Y(2i−1)j and an auxiliary capacitance wiring line C(2i−1) (or C2i). A thin film transistor Q(2i−1)jb which is an active element is arranged between the pixel electrode Y(2i−1)j and the source wiring line Sj. The gate wiring line G(2i−1) is connected to the gate terminals of the thin film transistors Q(2i−1)ja and Q(2i−1)jc, and a gate wiring line G2i is connected to the gate terminal of the thin film transistor Q(2i−1)jb.

Note that in the present embodiment a first active element is implemented by the thin film transistor Q(2i−1)ja, a first capacitance element is implemented by the auxiliary capacitance C(2i−1)jc, and a first pixel electrode is implemented by the pixel electrode X(2i−1)j. Note also that a second active element is implemented by the thin film transistor Q(2i−1)jb, a second capacitance element is implemented by the auxiliary capacitance C(2i−1)jb, and a second pixel electrode is implemented by the pixel electrode Y(2i−1)j. Furthermore, a third active element is implemented by the thin film transistor Q(2i−1)jc. Furthermore, a pixel electrode voltage shift portion is implemented by a connection relationship among the pixel electrode X(2i−1)j, the pixel electrode Y(2i−1)j, the auxiliary capacitance C(2i−1)jc, the auxiliary capacitance C(2i−1)jb, and the auxiliary capacitance wiring line Ci, and the auxiliary capacitance wiring line driver 500.

Liquid crystal is present between the pixel electrodes X(2i−1)j, Y(2i−1)j and a counter electrode Com. In terms of equivalence, a liquid crystal capacitance LC(2i−1)ja is arranged between the pixel electrode X(2i−1)j and the counter electrode Com, and a liquid crystal capacitance LC(2i−1)jb is arranged between the pixel electrode Y(2i−1)j and the counter electrode Corn. Then, light entering the liquid crystal (layer) from the backlight through the polarizing plate is polarized according to the magnitude of a voltage applied to the liquid crystal, whereby the display states of subpixels are controlled.

In the present embodiment, too, as shown in FIG. 7, a pixel formation portion P13 is arranged on the right side of a source wiring line S3, and a pixel formation portion P33 is arranged on the left side of the source wiring line S3. Namely, a pixel formation portion P(2i−1)j and a pixel formation portion P(2i+1)j which are provided for a source wiring line Sj are arranged on different sides (i.e., in a staggered manner) with reference to the source wiring line Sj. Hence, for example, by setting the polarity of an applied voltage to a source wiring line Sj to a positive polarity throughout a first frame period and to a negative polarity throughout a second frame period, and setting the polarity of an applied voltage to a source wiring line Sj+1 to a negative polarity throughout the first frame period and to a positive polarity throughout the second frame period, dot-reversal driving is performed. Namely, dot-reversal driving is performed without reversing the polarity of an applied voltage to a source wiring line every horizontal scanning period.

<2.3 Drive Method>

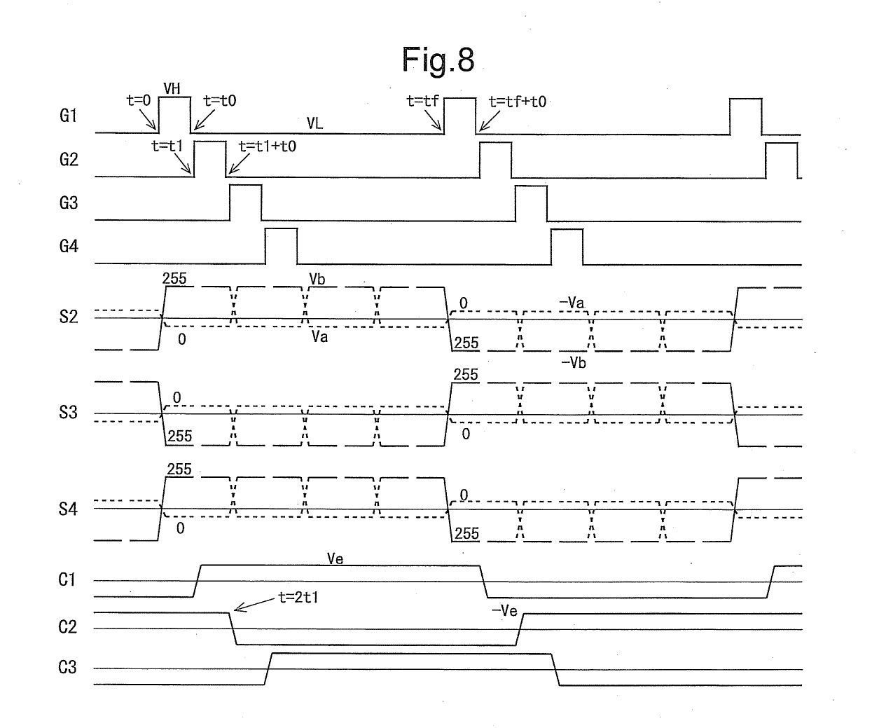

FIG. 8 is a signal waveform diagram for describing a drive method in the present embodiment. FIG. 8 shows the waveforms of a voltage applied to a gate wiring line G1, a voltage applied to a gate wiring line G2, a voltage applied to a gate wiring line G3, a voltage applied to a gate wiring line G4, a voltage applied to a source wiring line S2, a voltage applied to a source wiring line S3, a voltage applied to a source wiring line S4, a voltage applied to an auxiliary capacitance wiring line C1, a voltage applied to an auxiliary capacitance wiring line C2, and a voltage applied to an auxiliary capacitance wiring line C3.

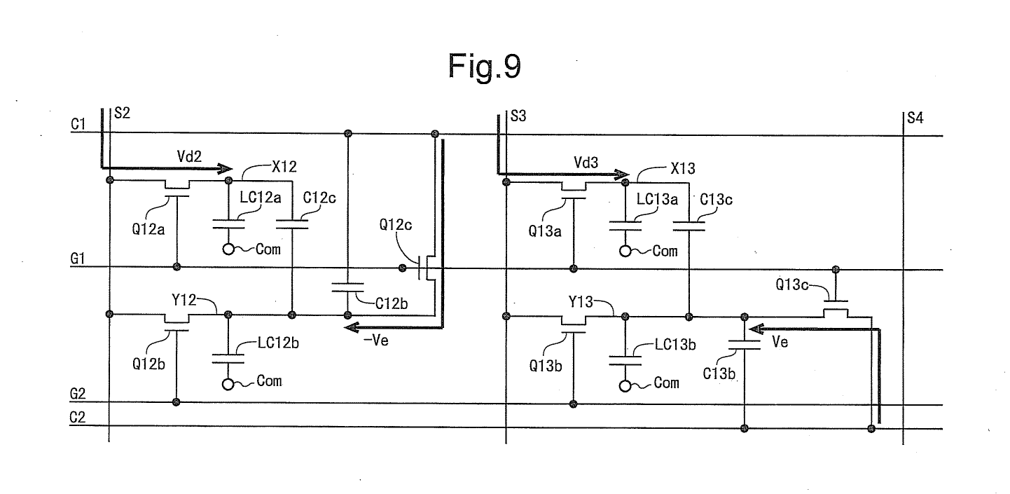

A drive method in the present embodiment will be described below with reference to FIGS. 7 and 8. First, at time point t=0, the gate driver 400 sets the voltage of the gate wiring line G1 to VH. By this, thin film transistors Q1ja and Q1jc provided for the gate wiring line G1 are placed in an on state. Then, a positive polarity voltage Vd2 is provided to a pixel electrode X12 from the source wiring line S2 by the source driver 300. In addition, a negative polarity voltage Vd3 is provided to a pixel electrode X13 from the source wiring line S3 by the source driver 300. Furthermore, by the auxiliary capacitance wiring line driver 500, a negative polarity voltage −Ve is provided to a pixel electrode Y12 from the auxiliary capacitance wiring line C1 and a positive polarity voltage Ve is provided to a pixel electrode Y13 from the auxiliary capacitance wiring line C2. FIG. 9 schematically shows the state for this time.

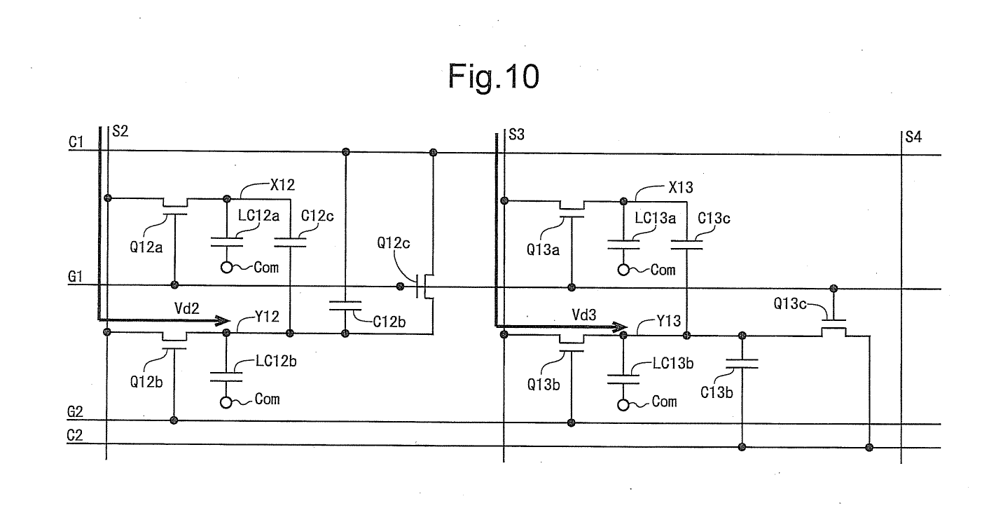

Then, at time point t=t0, the gate driver 400 sets the voltage of the gate wiring line G1 to VL. By this, the thin film transistors Q1ja and Q1jc provided for the gate wiring line G1 are placed in an off state. Thereafter, at time point t=t1, the gate driver 400 sets the voltage of the gate wiring line G2 to VH. By this, thin film transistors Q2ja and Q2jb provided for the gate wiring line G2 are placed in an on state. Then, a positive polarity voltage Vd2 is provided to the pixel electrode Y12 from the source wiring line S2 by the source driver 300. In addition, a negative polarity voltage Vd3 is provided to the pixel electrode Y23 from the source wiring line S3 by the source driver 300. FIG. 10 schematically shows the state for this time.

Then, at time point t=t1+t0, the gate driver 400 sets the voltage of the gate wiring line G2 to VL. By this, the thin film transistors Q2ja and Q2jb provided for the gate wiring line G2 are placed in an off state. Thereafter, at time point t=2t1 (timing at which the voltage of the gate wiring line G3 is set to VH), the auxiliary capacitance wiring line driver 500 changes the voltage of the auxiliary capacitance wiring line C1 from −Ve to Ve.

Meanwhile, the other end of an auxiliary capacitance C12b connected at its one end to the pixel electrode Y12 to which a positive polarity voltage is provided, is connected to the auxiliary capacitance wiring line C1. Therefore, at time point t=t0, a voltage (Vd2−(−Ve)) is applied between both ends of a capacitor C12c arranged between the pixel electrode X12 and the pixel electrode Y12. Here, when the voltage of the pixel electrode X12 at time point t=t1+t0 is Vs, the voltage Vs is obtained as shown in the following equations (20) to (22):

Clca(Vd2−Vc)+Cc(Vd2−(−Ve))=Clca(Vs−Vc)+Cc(Vs−Vd2) (20)

∴(Clca+Cc)Vs=(Clca+Cc)Vd2+Cc(Vd2+Ve) (21)

∴Vs=Vd2+(Cc/(Clca+Cc))(Vd2+Ve) (22)

where Clca is the capacitance value of a liquid crystal capacitance LC12a and Cc is the capacitance value of the auxiliary capacitance C12c. The voltage Vc is the voltage value of a counter electrode Com.

Then, when the voltage of the pixel electrode X12 after the voltage of the auxiliary capacitance wiring line C1 is changed from −Ve to Ve at time point t=2t1 is Vx and the voltage of the pixel electrode Y12 is Vy, the voltage Vx is obtained as shown in the following equations (23) to (25):

Clca(Vd2−Vc)+Cc(Vd2−(−Ve))=Clca(Vx−Vc)+Cc(Vx−Vy) (23)

∴(Clca+Cc)Vx=(Clca+Cc)Vd2+Cc(Vy+Ve) (24)

∴Vx=Vd2+(Cc/(Clca+Cc))(Vy+Ve) (25).

By the above equation (22) and the above equation (25), Vx−Vs is obtained as shown in the following equation (26):

$$\begin{matrix}Vx - Vs = ( Vd 2 + ( Cc / Clca + Cc ) ) ( Vy + Ve ) ) - \\ ( Vd 2 + ( Cc / ( Clca + Cc ) ) ( Vd 2 + Ve ) ) \\ = ( Cc / ( Clca + Cc ) ) ( Vy - Vd 2 ) .\end{matrix} \qquad ( 26 )$$

In addition, the voltage Vy is obtained as shown in the following equations (27) to (32):

$$\begin{matrix}Clcb ( Vd 2 - Vc ) + Cc ( Vd 2 - Vs ) + Cb ( Vd 2 - ( - Ve ) ) = Clcb ( Vy - Vc ) + Cc ( Vy - Vx ) + Cb ( Vy - Ve ) & ( 27 ) \\ ∴ ( Clcb + Cc + Cb ) Vy = ( Clcb + Cc + Cb ) Vd 2 + Cc ( Vx - Vs ) + Cb ( 2 Ve ) & ( 28 ) \\ ∴ ( Clcb + Cc + Cb ) Vy = ( Clcb + Cc + Cb ) Vd 2 + Cc ( Cc / ( Clca + Cc ) ) ( Vy - Vd 2 ) + Cb ( 2 Ve ) & ( 29 ) \\ ∴ ( Clcb + Cc + Cb ) ( Clca + Cc ) Vy = ( Clcb + Cc + Cb ) ( Clca + Cc ) Vd 2 + CcCc ( Vy - Vd 2 ) + Cb ( Clca + Cc ) ( 2 Ve ) & ( 30 ) \\ ∴ ( ( Clcb + Cb ) ( Clca + Cc ) + CcClca ) Vy = ( ( Clcb + Cb ) ( Clca + Cc ) + CcClca ) ( Vd 2 + Cb ( Clca + Cc ) ( 2 Ve ) & ( 31 ) \\ ∴ Vy = Vd 2 + ( Cb ( Clca + Cc ) / ( ( Clcb + Cb ) ( Clca + Cc ) + CcClca ) ) ( 2 Ve ) & ( 32 )\end{matrix}$$

where Clcb is the capacitance value of a liquid crystal capacitance LC12b and Cb is the capacitance value of the auxiliary capacitance C12b.

<2.4 Effects>

Effects in the present embodiment will be described. FIG. 11 shows the “relationship between the voltage Vd2 and the voltage Ve” to set the above-described Vx to 9 V when Cc=Cb=Clca=Clcb. As is grasped from FIG. 11, by adjusting the magnitude of the voltage Ve and the magnitude of the voltage Vd2, the voltage difference Vx−Vy between subpixels can be changed. This fact indicates that even if there are variations in the capacitance values Cc and Cb of the auxiliary capacitances C12c and C12b between panels, by adjusting the magnitude of the voltage Ve and the magnitude of the voltage Vd2 to appropriate magnitudes, desired voltages are provided to the pixel electrode X12 and the pixel electrode Y12.

Note that as is grasped from FIG. 11, by adjusting a voltage between subpixels, the CC driving effect also changes. Hence, even if a panel is designed such that a voltage Vd255 (of the source wiring line) associated with positive polarity gray level 255 is equal to a voltage −Vd0 (of the source wiring line) associated with negative polarity gray level 0, the following problem arises. Specifically, taking into account variations in capacitance values Cc and Cb, an adjustment to the above-described voltages Ve and Vd2 is required according to panel and thus there may be a case in which Vd255 and −Vd0 have extremely different values. Considering this fact, even if CC driving is not used, it is preferred to design such that applied voltages to pixel electrodes in pixel formation portions P(2i−1)j provided for a single source wiring line Sj have the same polarity throughout one frame period. In this regard, according to the present embodiment, as shown in FIG. 7, when taking a look at one source wiring line Sj, pixel formation portions P(2i−1)j and P(2i+1)j are alternately arranged on the left and right sides of the source wiring line Sj (arranged in a staggered manner). By such an arrangement, the polarities of applied voltages to the source wiring line Sj are made to be the same throughout one frame period, and thus, an increase in the amount of the charge and discharge currents of the source wiring line Sj is suppressed. By this, power consumption is reduced and an increase in the amount of heat generated in the source driver 300 is suppressed.

In addition, as is grasped from the waveform (see reference characters S2 to S4) of the voltage of a source wiring line Sj shown in FIG. 8, in the liquid crystal display device in the present embodiment, a change in the voltage of the source wiring line Sj occurs every 2t1 period. Hence, despite the fact that the number of gate wiring lines is twice that in the first embodiment, the number of times the source wiring line Sj is charged and discharged is equal to that in the first embodiment. By this, an increase in the amount of the charge and discharge currents of the source wiring line Sj is suppressed and thus an increase in power consumption is suppressed.

In addition, if the condition “Ve>0” is satisfied even after an adjustment to the voltages Ve and Vd2 is made, then the voltage Vy of a pixel electrode in a subpixel formation portion becomes larger than the voltage Vd2 provided from the source wiring line Sj (to the pixel electrode). Namely, even if the amplitude of an applied voltage to the source wiring line Sj is relatively small, a relatively large voltage can be applied to a pixel electrode in each subpixel formation portion. Therefore, an increase in the amplitude of an applied voltage to the source wiring line Sj is suppressed and thus heat generation in the source driver LSI is suppressed.

As described above, according to the present embodiment, a display device is implemented in which even if the amplitude of the voltage of a source wiring line is relatively small, the amplitudes of the voltages of subpixels can be increased and the voltage difference between the subpixels can be furthermore increased.

### 3. Third Embodiment

<3.1 Configuration>

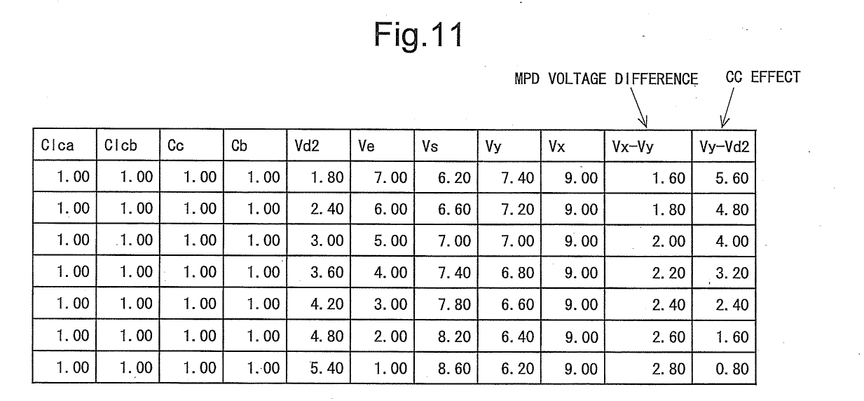

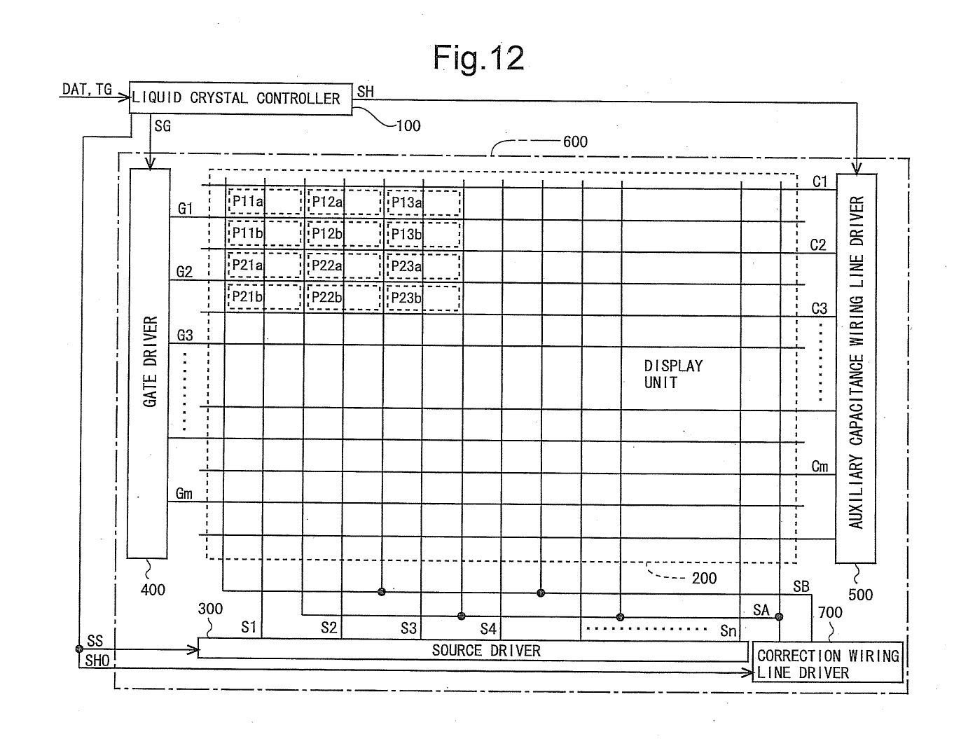

FIG. 12 is a block diagram showing an overall configuration of a display device according to a third embodiment of the present invention. In the present embodiment, in addition to the components provided in the above-described first and second embodiments, a correction wiring line driver 700 is provided in a liquid crystal panel 600. The correction wiring line driver 700 drives correction wiring lines SA and SB shown in FIG. 12, based on a correction wiring line driving control signal SHO provided from a liquid crystal controller 100. The operations of those components other than the correction wiring line driver 700 are the same as those in the first embodiment and thus description thereof is omitted.

<3.2 Configuration of Pixel Circuits>

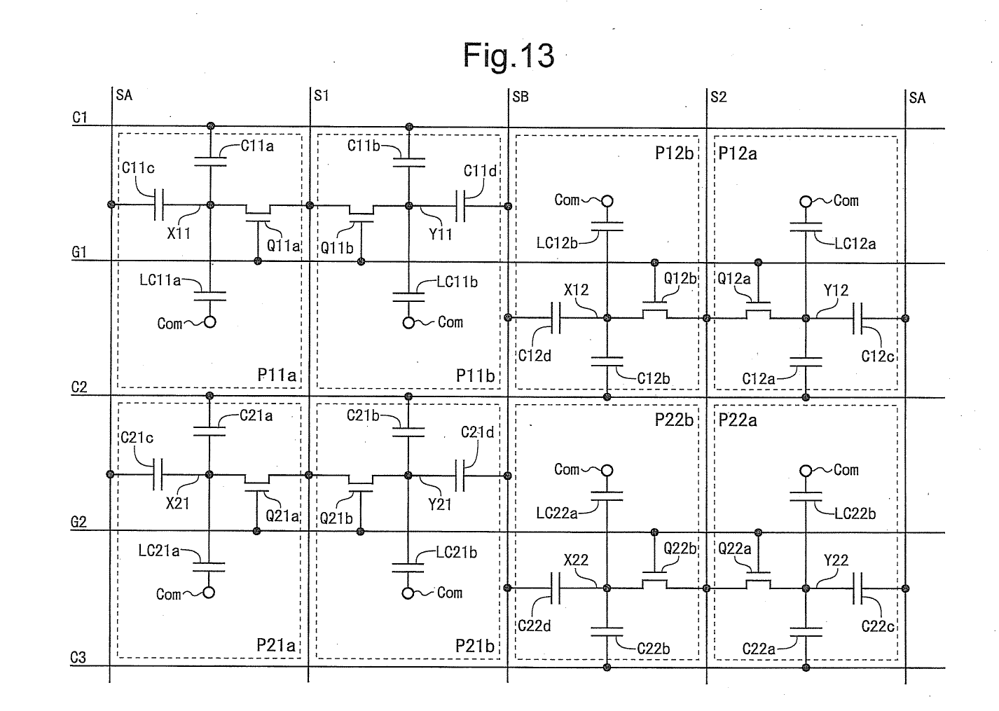

FIG. 13 is a circuit diagram showing the configuration of pixel circuits in the present embodiment. As shown in FIG. 13, two subpixel formation portions Pija and Pijb are arranged at an intersection of a source wiring line Sj and a gate wiring line G1. The first subpixel portion Pija is composed of a thin film transistor Qija which is an active element, a pixel electrode Xij, and auxiliary capacitances Cija and Cijc which are capacitors. The second subpixel portion Pijb is composed of a thin film transistor Qijb which is an active element, a pixel electrode Yij, and auxiliary capacitances Cijb and Cijd which are capacitors. The thin film transistor Qija is connected at its gate terminal to the gate wiring line G1, connected at its source terminal to the source wiring line Sj, and connected at its drain terminal to the pixel electrode Xij. The auxiliary capacitance Cija is arranged between the pixel electrode Xij and an auxiliary capacitance wiring line Ci (or an auxiliary capacitance wiring line Ci+1), and the auxiliary capacitance Cijc is arranged between the pixel electrode Xij and a correction wiring line SA. The thin film transistor Qijb is connected at its gate terminal to the gate wiring line Gi, connected at its source terminal to the source wiring line Sj, and connected at its drain terminal to the pixel electrode Yij. The auxiliary capacitance Cijb is arranged between the pixel electrode Yij and the auxiliary capacitance wiring line Ci (or the auxiliary capacitance wiring line Ci+1), and the auxiliary capacitance Cijd is arranged between the pixel electrode Yij and a correction wiring line SB.

Note that in the present embodiment a first active element is implemented by the thin film transistor Qija, a first capacitance element is implemented by the auxiliary capacitance Cija, a third capacitance element is implemented by the auxiliary capacitance Cijc, and a first pixel electrode is implemented by the pixel electrode Xij. Note also that a second active element is implemented by the thin film transistor Qijb, a second capacitance element is implemented by the auxiliary capacitance Cijb, a fourth capacitance element is implemented by the auxiliary capacitance Cijd, and a second pixel electrode is implemented by the pixel electrode Yij. Furthermore, a pixel electrode voltage shift portion is implemented by a connection relationship among the pixel electrode Xij, the auxiliary capacitance Cija, and the auxiliary capacitance wiring line Ci, a connection relationship among the pixel electrode Yij, the auxiliary capacitance Cijb, and the auxiliary capacitance wiring line Ci, and an auxiliary capacitance wiring line driver 500.

Liquid crystal is present between the pixel electrodes Xij, Yij and a counter electrode Com. In terms of equivalence, a liquid crystal capacitance LCija is arranged between the pixel electrode Xij and the counter electrode Com, and a liquid crystal capacitance LCijb is arranged between the pixel electrode Yij and the counter electrode Com. Then, light entering the liquid crystal (layer) from a backlight through a polarizing plate is polarized according to the magnitude of a voltage applied to the liquid crystal, whereby the display states of subpixels are controlled.

In the present embodiment, as shown in FIG. 13, the first subpixel portion Pija is arranged on the left side of the source wiring line Sj, and the second subpixel portion Pijb is arranged on the right side of the source wiring line Sj. Hence, when dot-reversal driving is performed, for the polarities of applied voltages to the source wiring line Sj, a positive polarity and a negative polarity alternately occur even during a first frame period. Hence, voltage setting is performed such that a source wiring line voltage Vd255 corresponding to positive polarity gray level 255 is equal to a source wiring line voltage −Vd0 corresponding to negative polarity gray level 0. In addition, voltage setting is performed such that a source wiring line voltage Vd0 corresponding to positive polarity gray level 0 is equal to a source wiring line voltage −Vd255 corresponding to negative polarity gray level 255.

<3.3 Drive Method>

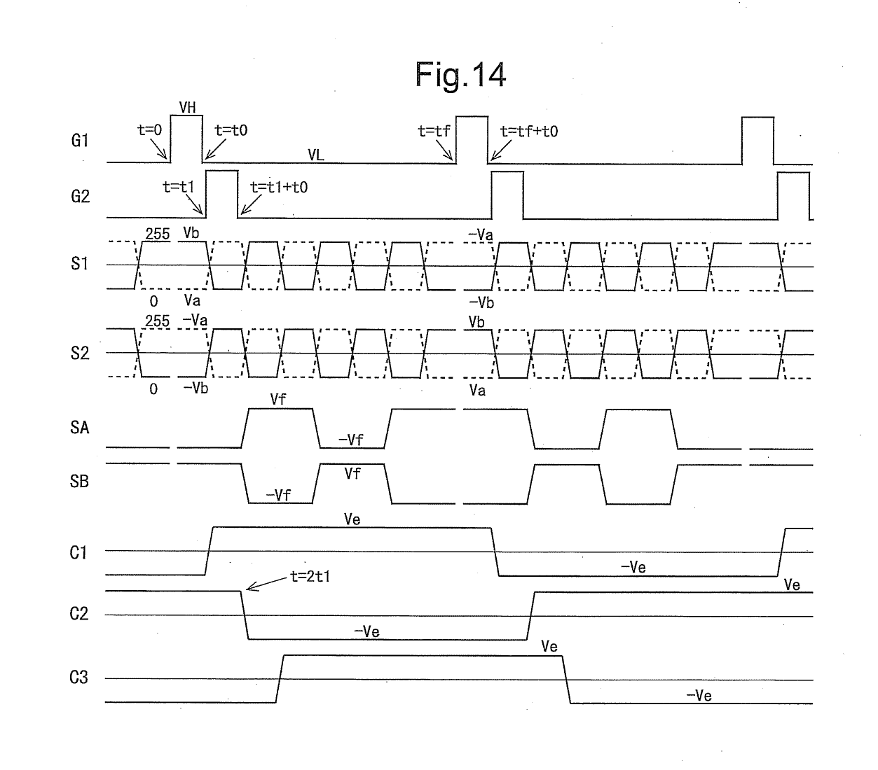

FIG. 14 is a signal waveform diagram for describing a drive method in the present embodiment. FIG. 14 shows the waveforms of a voltage applied to a gate wiring line G1, a voltage applied to a gate wiring line G2, a voltage applied to a source wiring line S1, a voltage applied to a source wiring line S2, a voltage applied to a correction wiring line SA, a voltage applied to a correction wiring line SB, a voltage applied to an auxiliary capacitance wiring line C1, a voltage applied to an auxiliary capacitance wiring line C2, and a voltage applied to an auxiliary capacitance wiring line C3. Note that in FIG. 14 Vd255 (a voltage corresponding to positive polarity grayscale value 255) is Vb, Vd0 (a voltage corresponding to positive polarity grayscale value 0) is Va, −Vd255 (a voltage corresponding to negative polarity grayscale value 255) is −Vb, and −Vd0 (a voltage corresponding to negative polarity grayscale value 0) is −Va.

A drive method in the present embodiment will be described below with reference to FIGS. 13 and 14. First, at time point t=0, a gate driver 400 sets the voltage of the gate wiring line G1 to VH. By this, thin film transistors Q1ja and Q1jb provided for the gate wiring line G1 are placed in an on state. Then, a positive polarity voltage is provided to pixel electrodes X11 and Y11 from the source wiring line S1 by a source driver 300. In addition, a negative polarity voltage is provided to pixel electrodes X12 and Y12 from the source wiring line S2 by the source driver 300.

Then, at time point t=t0, the gate driver 400 sets the voltage of the gate wiring line G1 to VL. By this, the thin film transistors Q1ja and Q1jb provided for the gate wiring line G1 are placed in an off state. Thereafter, at time point t=t1, the auxiliary capacitance wiring line driver 500 changes the voltage of the auxiliary capacitance wiring line C1 from −Ve to Ve. In addition, at time point t=t1, the gate driver 400 sets the voltage of the gate wiring line G2 to VH. By this, thin film transistors Q2ja and Q2jb provided for the gate wiring line G2 are placed in an on state. Then, a negative polarity voltage is provided to pixel electrodes X21 and Y21 from the source wiring line S1 by the source driver 300. In addition, a positive polarity voltage is provided to pixel electrodes X22 and Y22 from the source wiring line S2 by the source driver 300.

Then, at time point t=t1+t0, the gate driver 400 sets the voltage of the gate wiring line G2 to VL. By this, the thin film transistors Q2ja and Q2jb provided for the gate wiring line G2 are placed in an off state. Thereafter, at time point t=2t1 (timing at which the voltage of a gate wiring line G3 is set to VH), the auxiliary capacitance wiring line driver 500 changes the voltage of the auxiliary capacitance wiring line C2 from Ve to −Ve. In addition, at time point t=2t1, the correction wiring line driver 700 changes the voltage of the correction wiring line SA from −Vf to Vf and changes the voltage of the correction wiring line SB from Vf to −Vf.

Meanwhile, the other ends of auxiliary capacitances C11a and C11b connected at their one ends to the pixel electrodes X11 and Y11 to which a positive polarity voltage is provided, are connected to the auxiliary capacitance wiring line C1. In addition, the other end of an auxiliary capacitance C11c connected at its one end to the pixel electrode X11 is connected to the correction wiring line SA, and the other end of an auxiliary capacitance C11d connected at its one end to the pixel electrode Y11 is connected to the correction wiring line SB. Here, it is assumed that at time point t=t0 an arbitrary voltage Vda of a magnitude between Va and Vb, inclusive, is provided to the pixel electrode X11 and the pixel electrode Y11. At this time, when the voltage of the pixel electrode X11 at time point t=2t1 is Vx and the voltage of the pixel electrode Y11 is Vy, the voltage Vx is obtained as shown in the following equations (33) to (35):

Clca(Vda−Vc)+Ca(Vda−(−Ve))+Cc(Vda−(−Vf))=Clca(Vx−Vc)+Ca(Vx−Ve)+Cc(Vx−Vf) (33)

∴(Clca+Ca+Cc)Vx=(Clca+Ca+Cc)Vda+2CaVe+2CcVf (34)

∴Vx=Vda+(2CaVe+2CcVf)/(Clca+Ca+Cc) (35)

where Clca is the capacitance value of a liquid crystal capacitance LC11a, Ca is the capacitance value of the auxiliary capacitance C11a, and Cc is the capacitance value of the auxiliary capacitance C11c. Vc is the voltage value of counter electrode Com.

In a likewise manner, the voltage Vy is obtained as shown in the following equations (36) to (38):

Clcb(Vda−Vc)+Cb(Vda−(−Ve))+Cd(Vda−Vf)=Clcb(Vy−Vc)+Cb(Vy−Ve)+Cd(Vy−(−Vf)) (36)

∴(Clcb+Cb+Cd)Vy=(Clcb+Cb+Cd)Vda+2CbVe−2CdVf (37)

∴Vy=Vda+(2CbVe−2CdVf)/(Clcb+Cb+Cd) (38)

where Clcb is the capacitance value of a liquid crystal capacitance LC11b, Cb is the capacitance value of the auxiliary capacitance C11b, and Cd is the capacitance value of the auxiliary capacitance C11d.

By the above equation (35) and the above equation (38), the voltage difference between the pixel electrode X11 and the pixel electrode Y11 is represented by the following equation (39):

Vx−Vy=(2CaVe+2CcVf)/(Clca+Ca+Cc)−(2CbVe−2CdVf)/(Clcb+Cb+Cd) (39).

<3.4 Effects>

Effects in the present embodiment will be described. When, in the configuration shown in FIG. 13, a pixel circuit is designed such that Clca=Clcb, Ca=Cb, and Cc=Cd, the above equation (39) can be transformed into the following equation (40):

Vx−Vy=4CcVf/(Clca+Ca+Cc) (40)

As is grasped from the above equation (40), regardless of the magnitudes of the capacitance values Cc, Clca, and Ca, by adjusting the magnitude of the voltage Vf, an arbitrary voltage difference can be generated between a pixel electrode Xij and a pixel electrode Yij.

Note that this voltage difference Vx−Vy between subpixels is only generated during a period during which SA in FIG. 14 is Vf and SB is −Vf. During the other half period, SA is −Vf and SB is Vf, as are at time point t=t0, and thus, Vx−Vy is zero.

Note that in the present embodiment the auxiliary capacitance Cija and the auxiliary capacitance Cijb are composed of homogeneous first conductive films, insulating films, and second conductive films. By this, when a panel is designed such that the capacitance values of two capacitances are equal, the first conductive films, second conductive films, and insulating films of the two capacitances are designed such that their forms and sizes are the same. Hence, even if the form or size is changed due to variations caused by etching conditions, etc., since two capacitances change in the same manner, the capacitance values of the two capacitances are equal.

This also applies to the case of the auxiliary capacitance Cijc and the auxiliary capacitance Cijd.

From the above, according to the present embodiment, a voltage difference can be generated between a pixel electrode Xij and a pixel electrode Yij to which voltages Vda of equal magnitudes are provided from a source wiring line Sj and the grayscale characteristics thereof can be changed, and thus, the viewing angle is expanded.

In addition, in the present embodiment, the average voltage of the voltage of the pixel electrode X11 and the voltage of the pixel electrode Y11 is obtained as shown in the following equation (41):

(Vx+Vy)/2=Vda+(2CaVe)/(Clca+Ca+Cc) (41).

As is grasped from the above equation (41), regardless of the magnitudes of the capacitance values Cc, Clca, and Ca, by adjusting the magnitude of the voltage Ve, the average voltage of the voltage of a pixel electrode Xij and the voltage of a pixel electrode Yij can be changed to an arbitrary magnitude. By this, the amplitude of an applied voltage to a source wiring line Sj can be reduced and the amount of the charge and discharge currents of the source wiring line Sj is reduced and thus power consumption is reduced.

Note that although in the present embodiment, as shown in FIG. 13, a pixel electrode Xij is arranged on the left side of a source wiring line Sj and a pixel electrode Yij is arranged on the right side of the source wiring line Sj, the present invention is not limited thereto. The configuration may be such that one of the pixel electrodes Xij and Yij is arranged on the upper side of a gate wiring line G1 and the other one of the pixel electrodes Xij and Yij is arranged on the lower side of the gate wiring line G1.

<4. Others>

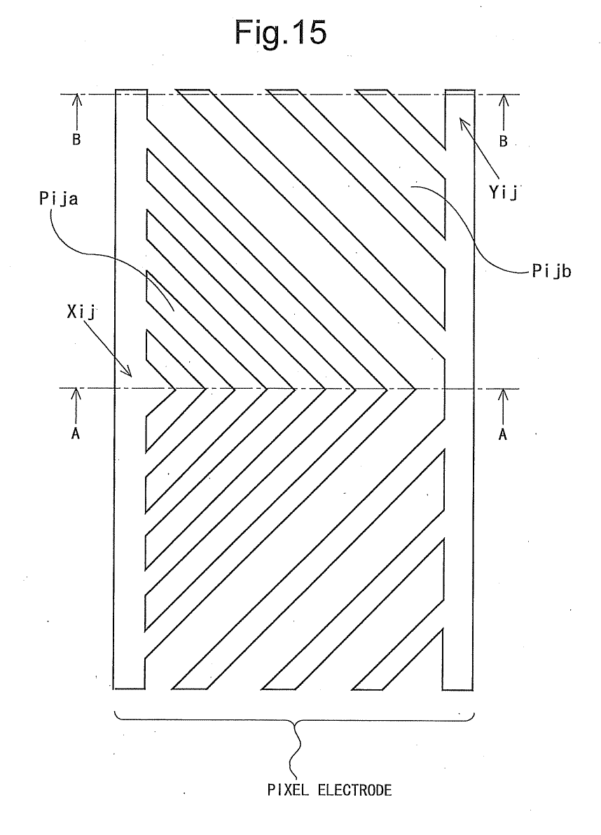

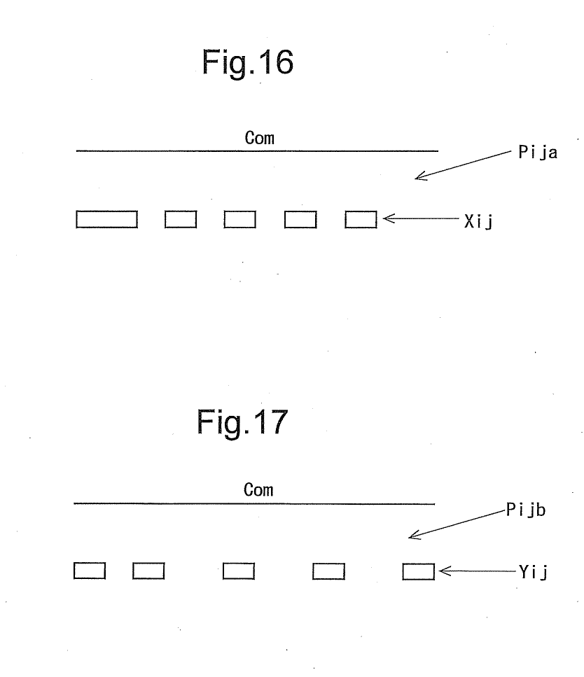

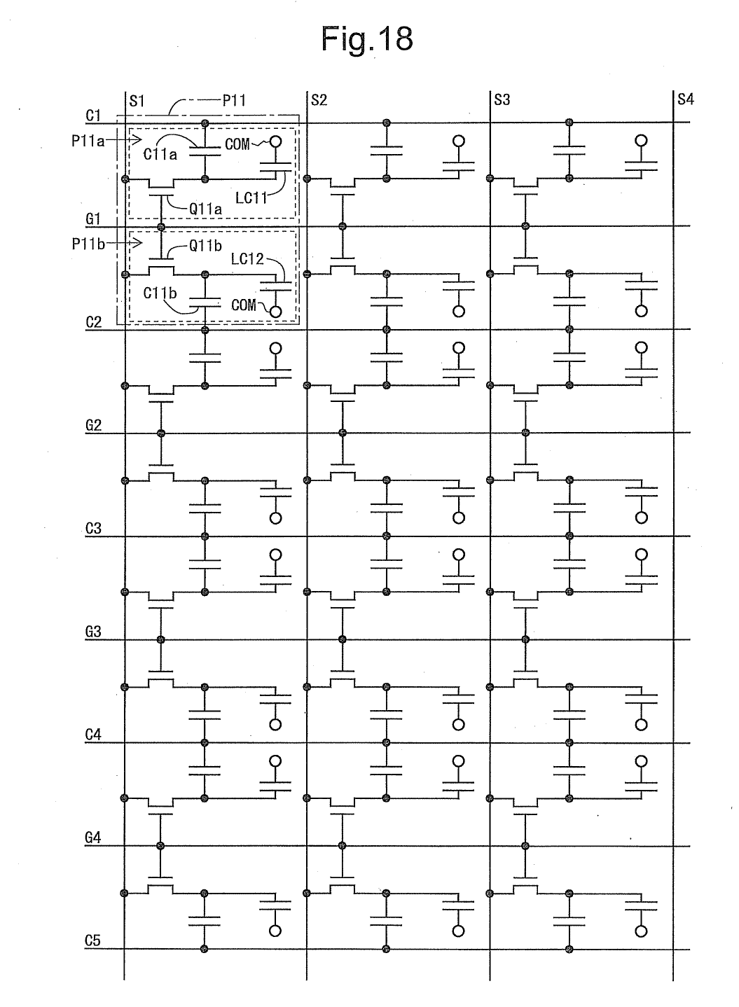

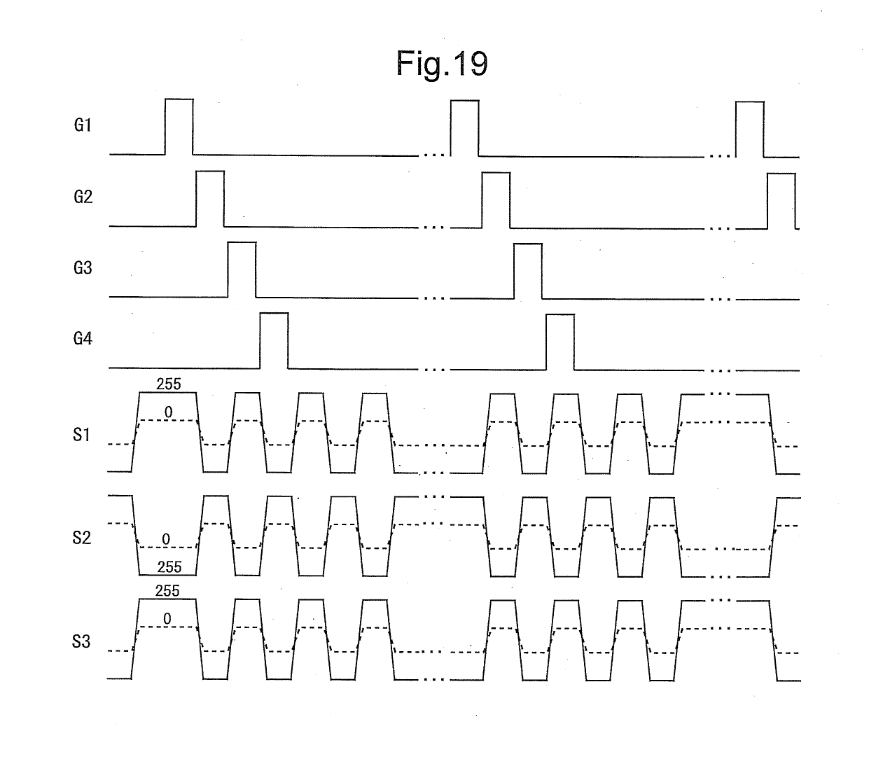

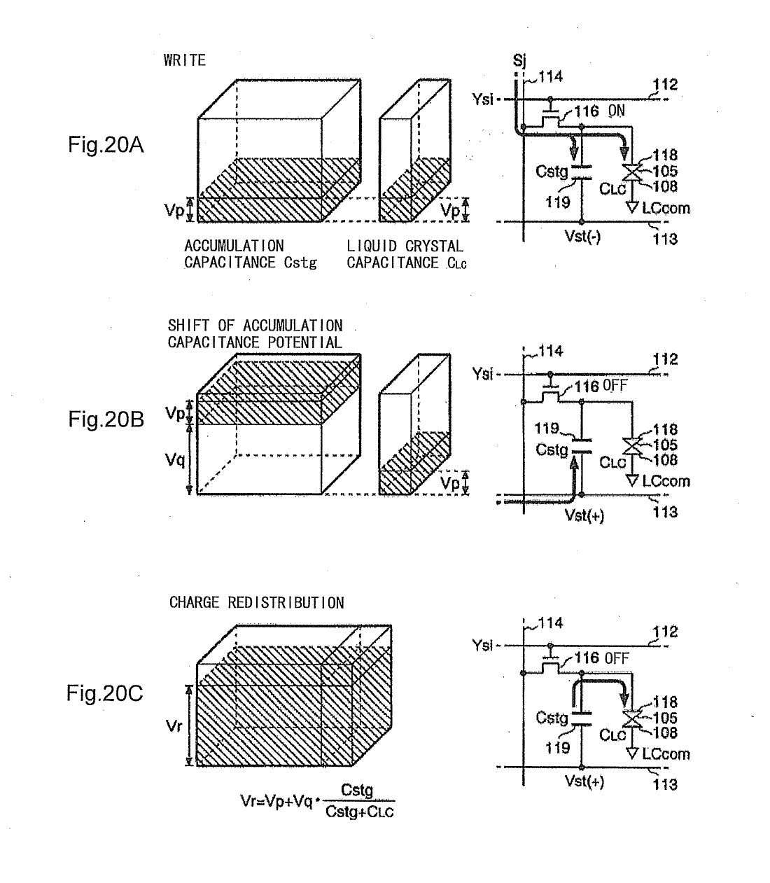

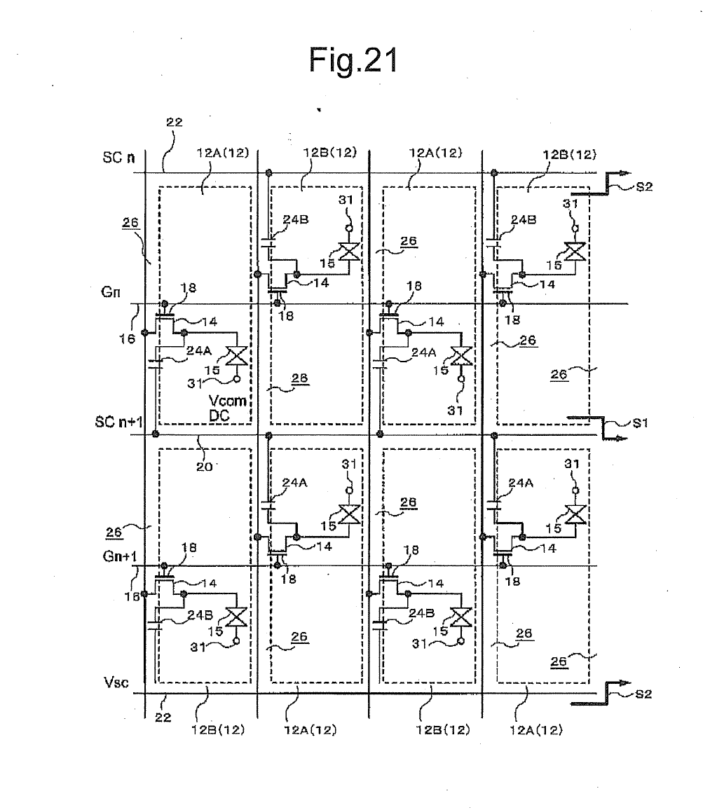

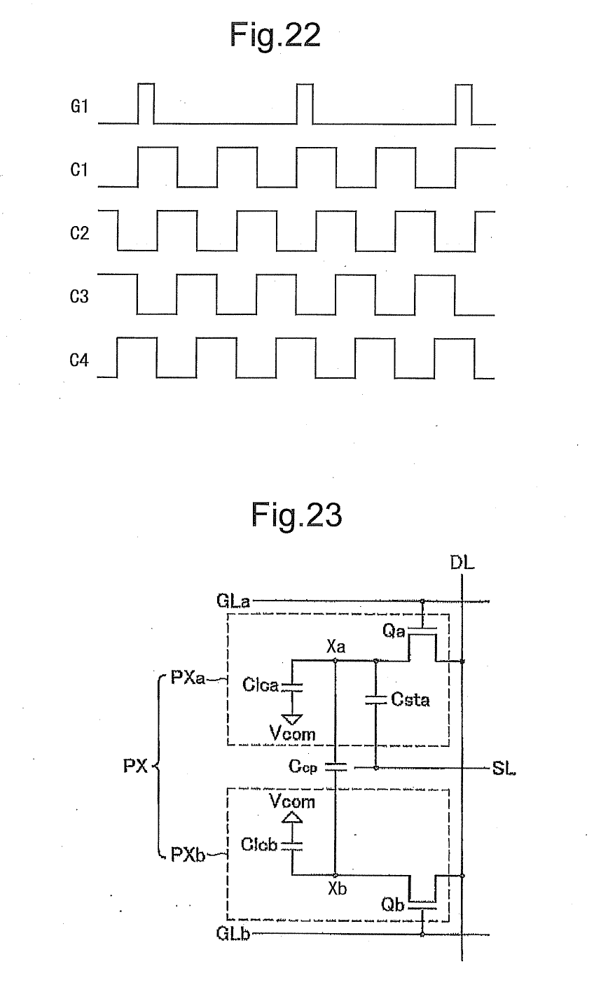

For the above-described embodiments, even when the voltage difference between subpixels is small (or when there is no voltage difference), by adopting different electrode patterns between the pixel electrode Xij and the pixel electrode Yij, the magnitude of an electric field received by liquid crystal can be made different between a first subpixel portion Pija and a second subpixel portion Pijb. This will be described with reference to FIGS. 15 to 17. FIG. 15 is a diagram showing the electrode patterns of pixel electrodes. FIG. 16 is a cross-sectional view along line A-A of FIG. 15. FIG. 17 is a cross-sectional view along line B-B of FIG. 15. For example, as shown in FIG. 15, it is considered to make the width (punching) between electrodes in a pixel electrode Xij in a first subpixel portion Pija relatively small and make the width (punching) between electrodes in a pixel electrode Yij in a second subpixel portion Pijb relatively large. By thus making the width (punching) between electrodes different between the pixel electrode Xij and the pixel electrode Yij, even when voltages of equal magnitudes are provided to the pixel electrode Xij and the pixel electrode Yij, the electric field strength received by liquid crystal can be made different between the first subpixel portion Pija and the second subpixel portion Pijb. This fact is also grasped from the cross-sectional views shown in FIGS. 16 and 17. The electric field strength distribution varies between the first subpixel portion Pija and the second subpixel portion Pijb and the liquid crystal control state varies between the two. Since the grayscale characteristics vary between the first subpixel portion Pija and the second subpixel portion Pijb, even when the voltage difference between the subpixels is relatively small, a viewing angle expansion effect is obtained. By thus making the width (punching) between electrodes different between subpixels, even if there is no voltage difference between the subpixels, the grayscale characteristics vary between the subpixels and thus a desired viewing angle expansion effect is expected to be obtained.

### DESCRIPTION OF REFERENCE CHARACTERS

100: LIQUID CRYSTAL CONTROLLER
200: DISPLAY UNIT
300: SOURCE DRIVER (VIDEO SIGNAL LINE DRIVE CIRCUIT)
400: GATE DRIVER (SCANNING SIGNAL LINE DRIVE CIRCUIT)
500: AUXILIARY CAPACITANCE WIRING LINE DRIVER
600: LIQUID CRYSTAL PANEL
Ci (i=1 to m): AUXILIARY CAPACITANCE WIRING LINE
G1 (i=1 to m): GATE WIRING LINE
Sj (j=1 to n): SOURCE WIRING LINE
Pij: PIXEL FORMATION PORTION
Pija: FIRST SUBPIXEL PORTION
Pijb: SECOND SUBPIXEL PORTION
Cija: CAPACITOR (FIRST CAPACITANCE ELEMENT)
Cijb: CAPACITOR (SECOND CAPACITANCE ELEMENT)
Qija: THIN FILM TRANSISTOR (FIRST ACTIVE ELEMENT)
Qijb: THIN FILM TRANSISTOR (SECOND ACTIVE ELEMENT)
Xij: PIXEL ELECTRODE (FIRST PIXEL ELECTRODE)
Yij: PIXEL ELECTRODE (SECOND PIXEL ELECTRODE)

1. A display device comprising:
a pixel formation portion composed of a first subpixel portion including a first active element, a first capacitance element, and a first pixel electrode; and a second subpixel portion including a second active element, a second capacitance element, and a second pixel electrode;
a video signal line electrically connected to the first pixel electrode through the first active element, and electrically connected to the second pixel electrode through the second active element;
a scanning signal line provided to intersect the video signal line, and transmitting a scanning signal for controlling conducting/non-conducting states of the first active element and/or the second active element;
an auxiliary capacitance wiring line electrically connected to the first pixel electrode through the first capacitance element, and electrically connected to the second pixel electrode through the second capacitance element; and
a pixel electrode voltage shift portion that changes applied voltages to the first pixel electrode and the second pixel electrode by changing an applied voltage to the auxiliary capacitance wiring line, wherein
the pixel electrode voltage shift portion changes the applied voltages to the first pixel electrode and the second pixel electrode, whereby an effective voltage of the first pixel electrode is made different in magnitude from an effective voltage of the second pixel electrode.

2. The display device according to claim 1, wherein
during each frame period,
during a first period, voltages which are determined according to an image to be displayed are provided to the first pixel electrode and the second pixel electrode from the video signal line, the first period being a period during which the first active element and/or the second active element are(is) placed in a conducting state based on the scanning signal, and
during a second period, the pixel electrode voltage shift portion changes the applied voltage to the auxiliary capacitance wiring line, whereby different voltages are provided to the first pixel electrode and the second pixel electrode, the second period being a period subsequent to the first period.

3. The display device according to claim 1, wherein a capacitance value of the first capacitance element and a capacitance value of the second capacitance element differ from each other.

4. The display device according to claim 1, wherein when taking a look at one video signal line, a plurality of pixel formation portions including a first and a second active element are arranged in a staggered manner on both sides of the video signal line, the first and second active elements being electrically connected to the video signal line.

5. The display device according to claim 2, wherein
a first scanning signal line and a second scanning signal line are provided as the scanning signal line, the first scanning signal line transmitting a scanning signal for controlling the conducting/non-conducting states of the first active element, and the second scanning signal line transmitting a scanning signal for controlling the conducting/non-conducting states of the second active element,
the pixel formation portion includes a third active element connected at its control terminal to the first scanning signal line, connected at its one conduction terminal to the second pixel electrode, and connected at its other conduction terminal to the auxiliary capacitance wiring line,
the first capacitance element is connected at its one end to the first pixel electrode and connected at its other end to the second pixel electrode,
the second capacitance element is connected at its one end to the second pixel electrode and connected at its other end to the auxiliary capacitance wiring line,
the first active element is connected at its conduction control terminal to the first scanning signal line, connected at its one conduction terminal to the video signal line, and connected at its other conduction terminal to the first pixel electrode, and
the second active element is connected at its conduction control terminal to the second scanning signal line, connected at its one conduction terminal to the video signal line, and connected at its other conduction terminal to the second pixel electrode.

6. The display device according to claim 5, wherein
during a first half period of the first period, the first active element and the third active element are placed in a conducting state and the second active element is placed in a non-conducting state, and
during a second half period of the first period, the first active element and the third active element are placed in a non-conducting state and the second active element is placed in a conducting state.

7. The display device according to claim 1, further comprising:
a first and a second correction wiring line intersecting the auxiliary capacitance wiring line;
a third capacitance element connected at its one end to the first pixel electrode and connected at its other end to the first correction wiring line; and
a fourth capacitance element connected at its one end to the second pixel electrode and connected at its other end to the second correction wiring line, wherein
the first capacitance element is connected at its one end to the first pixel electrode and connected at its other end to the auxiliary capacitance wiring line, and
the second capacitance element is connected at its one end to the second pixel electrode and connected at its other end to the auxiliary capacitance wiring line.

8. The display device according to claim 1, wherein an electrode pattern of the first pixel electrode and an electrode pattern of the second pixel electrode differ from each other.

9. A drive method for a display device including a pixel formation portion composed of a first subpixel portion including a first active element, a first capacitance element, and a first pixel electrode; and a second subpixel portion including a second active element, a second capacitance element, and a second pixel electrode; a video signal line electrically connected to the first pixel electrode through the first active element, and electrically connected to the second pixel electrode through the second active element; a scanning signal line provided to intersect the video signal line, and transmitting a scanning signal for controlling conducting/non-conducting states of the first active element and/or the second active element; and an auxiliary capacitance wiring line electrically connected to the first pixel electrode through the first capacitance element, and electrically connected to the second pixel electrode through the second capacitance element, the drive method comprising:
a first driving step of providing voltages which are determined according to an image to be displayed to the first pixel electrode and the second pixel electrode from the video signal line; and
a second driving step of changing the applied voltages to the first pixel electrode and the second pixel electrode by changing an applied voltage to the auxiliary capacitance wiring line, wherein
by changing the applied voltages to the first pixel electrode and the second pixel electrode in the second driving step, an effective voltage of the first pixel electrode and an effective voltage of the second pixel electrode are set to different magnitudes.
